(19) United States
(12) Patent Application Publication
(10) Pub. No.: US 2025/0093304 A1
(43) Pub. Date: Mar. 20, 2025

(54) ULTRASONIC INSPECTION APPARATUS AND METHOD USING THE SAME

(71) Applicant: MIT Co., Ltd., Siheung-si (KR)

(72) Inventors: Ju Ho KIM, Hwaseong-si (KR); Jong Myoung Choi, Siheung-si (KR)

(21) Appl. No.: 18/830,811

(22) Filed: Sep. 11, 2024

(30) Foreign Application Priority Data
Sep. 15, 2023 (KR) 10-2023-0122868
Oct. 5, 2023 (KR) 10-2023-0132157
Nov. 1, 2023 (KR) 10-2023-0148841
Nov. 7, 2023 (KR) 10-2023-0152261

(51) Int. Cl. G01N 29/06; G01N 29/04; G01N 29/265; G01N 29/44

(52) U.S. Cl. CPC G01N 29/0654; G01N 29/041; G01N 29/265; G01N 29/4436; G01N 2291/044; G01N 2291/2638

(57) ABSTRACT

The present invention relates to an ultrasonic inspection apparatus and provided an ultrasonic inspection apparatus including an inspection module that includes a plurality of probes performing ultrasonic scanning on an object to be inspected, a processing module that transmits an ultrasonic generation signal so that the plurality of probes generate an ultrasonic signal, and generates an image of an inspection surface of the object to be inspected based on an ultrasonic reflection signal detected by the probes, and a control module that controls an ultrasonic scanning operation of the inspection module and controls signal processing of the processing module, in which the control module controls a focusing position of the probes by adjusting a distance between each of the plurality of probes and the object to be inspected.

### CROSS-REFERENCE TO RELATED APPLICATION

This application claims priority to Korean Patent Applications Nos. 10-2023-0122868, filed on Sep. 15, 2023, 10-2023-0132157, filed on Oct. 15, 2023, 10-2023-0148841, filed on Nov. 1, 2023, and 10-2023-0152261, filed on Nov. 7, 2023, and all the benefits accruing therefrom under 35 U.S.C. § 119, the contents of which are incorporated by reference in their entirety.

### BACKGROUND

The present invention relates to an ultrasonic inspection apparatus and a method using the same.

A technology for acquiring images of an inspection target using signals having a frequency in an ultrasonic wave range is being utilized in various fields such as a medical field targeting internal organs or fetuses during pregnancy, and a non-destructive inspection (NDT) field for detecting internal defects without deforming the manufacturing results.

For example, defect detection using an ultrasonic inspection method may be performed even for semiconductor devices on which complex circuit patterns are formed. In the past, the ultrasonic inspection could be performed for purposes such as selecting only some of the finished semiconductor devices and calculating a defect rate thereof.

However, in relation to an autonomous driving technology that has been developing recently, the standards for defect inspection of semiconductors for autonomous vehicles are gradually being strengthened in order to prevent vehicle accidents due to device defects.

Therefore, in the fields requiring a very high level of manufacturing quality, such as autonomous driving, the development of an improved ultrasonic inspection apparatus that has high inspection precision to detect potential defective elements in semiconductor devices in advance, and can reduce the inspection time so that a full inspection of semiconductor devices rather than selective inspection can be performed may be required.

In this regard, Korean Registered Patent No. 10-2125751 (hereinafter referred to as “prior art document”) discloses an ultrasonic imaging device capable of simultaneously imaging a plurality of bonding surfaces of a workpiece and an image generation method of the ultrasonic imaging device.

The prior art document discloses a method of performing an ultrasonic inspection on a plurality of bonding surfaces using a single probe, but performing an ultrasonic inspection on a basically flat bonding surface, and does not disclose an ultrasonic inspection method on a curved bonding surface that is not flat.

Various samples may warp or become non-flat or non-horizontal due to various reasons such as differences in thermal expansion coefficients between materials during a manufacturing process. If an ultrasonic inspection is performed on such a sample, a curved inspection surface exists thereon, making it impossible to perform an accurate ultrasonic inspection.

That is, as shown in FIG. 1, if ultrasonic scanning is performed on an inspection surface 3 of a curved sample 1 after focusing a focus of a probe 11 through A-scan at a reference position, since a height of the probe 11 is fixed and the inspection surface 3 of the curved sample 1 is curved, an inspection position having an inconsistent depth of focus occurs during a scanning process, resulting in a disadvantage of not being able to perform an accurate ultrasonic inspection.

In addition, since the prior art document performs an ultrasonic inspection on a plurality of bonding surfaces using one probe, but simultaneously performs the ultrasonic inspection on a plurality of bonding surfaces by performing focusing on a middle point of adjacent bonding surfaces, the precision of the ultrasonic inspection for each bonding surface cannot be guaranteed, and since only one probe is used, there is still a limit to the speed of the ultrasonic inspection.

Examples of prior art documents include Korean Registered Patent No. 10-2125751 (Published date: Jun. 23, 2020, Title of the invention: Ultrasonic imaging device and image generation method of ultrasonic imaging device).

### SUMMARY

The present invention has been created to solve the problems of the prior art described above, and the problems to be solved according to one embodiment of the present invention are as follows.

First, the present invention aims to provide an ultrasonic inspection apparatus that can perform rapid and highly precise ultrasonic inspection even on a sample having non-flat or non-horizontal inspection surfaces, such as a curved sample.

Second, the present invention aims to provide an ultrasonic inspection apparatus for a curved sample that can perform rapid ultrasonic inspection with guaranteed precision using an optimal scanning pattern on a sample having non-uniform degrees of curvature.

Third, the present invention aims to provide an ultrasonic inspection apparatus that improves the speed and precision of ultrasonic inspection on an object to be inspected having a plurality of bonding surfaces.

Fourth, the present invention aims to provide an ultrasonic inspection apparatus capable of mass inspections that can significantly saves the time, effort, and cost for ultrasonic inspections on a plurality of objects to be inspected by allowing the ultrasonic inspection to be simultaneously performed on the plurality of objects to be inspected seated on an inspection stage, thereby improving the efficiency of the ultrasonic inspection. In addition, the present invention aims to provide an ultrasonic inspection apparatus capable of improving the speed and precision of the ultrasonic inspection on an object to be inspected having a plurality of bonding surfaces.

As an ultrasonic inspection apparatus proposed to solve the above problems, there is provided an ultrasonic inspection apparatus including an inspection module that includes a plurality of probes performing ultrasonic scanning on an object to be inspected, a processing module that transmits an ultrasonic generation signal so that the plurality of probes generate an ultrasonic signal, and generates an image of an inspection surface of the object to be inspected based on an ultrasonic reflection signal detected by the probes, and a control module that controls an ultrasonic scanning operation of the inspection module and controls signal processing of the processing module, in which the control module controls a focusing position of the probes by adjusting a distance between each of the plurality of probes and the object to be inspected.

The plurality of probes may be divided into a first probe that performs ultrasonic scanning for calculating displacement information on the inspection surface of the object to be inspected and a second probe that performs ultrasonic scanning for an ultrasonic inspection of the inspection surface, and the processing module may perform gate processing on the ultrasonic reflection signal detected by the second probe to output a displacement of the ultrasonic reflection signal for the inspection surface and generate an image of the inspection surface based on the displacement, include a displacement information calculation unit that calculates displacement information corresponding to a displacement value in a height direction for a reference position of the inspection surface using the ultrasonic reflection signal detected by the first probe, and perform control so that ultrasonic scanning is performed while a height of the second probe is varied based on the displacement information calculated by the displacement information calculation unit.

The first and second probes may be respectively connected to mounting jigs, and may be connected to the mounting jigs in a first direction arrangement form in which the first and second probes are arranged in a row along a preset scan line or in a second direction arrangement form in which the first and second probes are arranged one by one along arrangement directions of at least two or more scan lines.

When the first and second probes are arranged in the first direction arrangement form, the processing module may perform control so that ultrasound scanning for a (k+1)-th scan line is performed while the height of the second probe is varied based on displacement information calculated using the ultrasonic reflection signal detected by the first probe for a k-th scan line.

The processing module may perform control so that the first probe performs ultrasonic scanning for calculating displacement information for the (k+1)-th scan line when ultrasonic scanning is performed for the (k+1)-th scan line while the height of the second probe is varied, and the displacement information calculation unit may calculate the displacement information for the (k+1)-th scan line using the ultrasonic reflection signal detected for the (k+1)-th scan line.

When the first and second probes are arranged in the second direction arrangement form, the processing module may perform control so that ultrasound scanning for a k-th scan line is performed while the height of the second probe is varied based on displacement information calculated using the ultrasonic reflection signal detected by the first probe for the k-th scan line.

The processing module, when ultrasonic scanning is performed for the k-th scan line while the height of the second probe is varied, may perform control so that the first probe performs ultrasonic scanning for calculating displacement information for a (k+1)-th scan line and the displacement information calculation unit calculates displacement information using the ultrasonic reflection signal detected for the (k+1)-th scan line.

The mounting jigs may be configured to move in the first direction or the second direction, the processing module may include a curvature information calculation unit that calculates curvature information based on the displacement information acquired through the first probe when the mounting jigs move, and the curvature information calculation unit may calculate unit curvature information for each preset unit section of the inspection surface, compare accumulated curvature information for a first to n-th sections with the unit curvature information of an (n+1)-th section, and determine the (n+1)-th section as an abnormal section when the unit curvature information of the (n+1)-th section exceeds a preset range compared to the accumulated curvature information.

The curvature information calculation unit may be controlled to compute the unit curvature information for the (n+1) section again in such a way that, firstly, if the (n+1)-th section is determined to be an abnormal section, secondly, the first probe is caused to be returned to a starting point of the (n+1)-th section through the mounting jig.

The curvature information calculation unit may calculate the accumulated curvature information using an average value of the unit curvature information of each of the first to nth sections, and the preset range may be a range that varies as ultrasound scanning is performed of being calculated based on a standard deviation of the unit curvature information of each of the first to nth sections.

The processing module may further include a scanning pattern setting unit that manages a scanning pattern corresponding to separation information between scanning points for each of scan lines of the first and second probes, and the scanning pattern setting unit may arrange the scanning points of each scan line at equal intervals or at different intervals.

When the first and second probes are in the first direction arrangement form, scanning points of each of a k-th scan line and a (k+1)-th scan line may be separated from each other by equal intervals, and the k-th scan line and the (k+1)-th scan line may be formed with the same scanning pattern.

When the first and second probes are in the second direction arrangement form, scanning points of each of a k-th scan line and a (k+1)-th scan line may be separated from each other by equal intervals or by different intervals, and the k-th scan line and the (k+1)-th scan line may be formed the same scanning pattern.

The processing module may further include a height adjustment unit that calculates a height adjustment value for each probe and provide the height adjustment value to the control module so that focusing may be performed for each bonding surface corresponding to each probe, and the height adjustment unit may use height corresponding information of each probe at which a displacement of the ultrasonic reflection signal for each bonding surface corresponding to each probe is maximized as the height adjustment value.

The height adjustment unit may calculate a thickness of each layer of the object to be inspected through a time difference of the ultrasonic reflection signal for each bonding surface, calculate the separation distance between the specific bonding surface and each of other bonding surfaces, and then provide each calculated separation distance as a height adjustment value for each of other probes to the control module.

The height adjustment unit may sequentially calculate the height adjustment value for each of other probes corresponding to each of other bonding surfaces from another bonding surface located close to the specific bonding surface to another bonding surface located far from the specific bonding surface in order and provide the height adjustment values to the control module, and the height adjustment value for a specific another probe may be determined by calculating a separation distance between a corresponding another specific bonding surface and an immediately previous bonding surface corresponding to an immediately previous probe for which the height adjustment value calculation is completed immediately before.

The separation distance may be determined by calculating a thickness of a layer of an object to be inspected located between the another specific bonding surface and the immediately previous bonding surface through an ultrasonic reflection signal of the immediately previous probe for which the calculation of the height adjustment value is completed.

The plurality of probes may be divided into a first probe that performs ultrasonic scanning for calculating displacement information on the inspection surface of the object to be inspected and a second probe that performs ultrasonic scanning for ultrasonic inspection of the inspection surface, and the processing module may further include an region division unit that computes layer shape information by calculating the thickness of the layer of the object to be inspected through the height adjustment unit based on the displacement information calculated using the ultrasonic reflection signal detected by the first probe, and divides a region of the object to be inspected into a first to m-th regions by calculating regions having the same layer shape information for a plane of the object to be inspected.

The processing module may further include a region determination unit that sets an ultrasonic performance region and an ultrasonic omission region by determining in a preset manner whether to perform an ultrasonic inspection by the second probe for the first to m-th regions divided by the region division unit.

The k-th region divided by the region division unit (wherein, k is a natural number less than or equal to m) may be a continuous region based on a plane, and the region determination unit may determine that the ultrasonic inspection by the second probe is omitted for a region having the same layer arrangement pattern among the first to m-th regions when the k-th region is set as an ultrasonic omission region.

An inspection stage having a plurality of seating portions, each of which seats the object to be inspected may be further included, the inspection stage may further include a plurality of seating regions separated from each other, and at least two seating portions are formed in a row in each of the seating regions, the plurality of probes may be classified into at least two probe groups, and each of the probe groups may be composed of at least one probe, and each of the probe groups may be connected to the mounting jig so as to be correspondingly arranged in each of the seating regions, perform ultrasonic scanning on a plurality of objects to be inspected seated on the corresponding seating region, and individual probes constituting the probe group may be connected to the mounting jigs through adjustment connection parts, so that positions of the probes in the horizontal direction may be adjusted.

### BRIEF DESCRIPTION OF THE DRAWINGS

Exemplary embodiments can be understood in more detail from the following description taken in conjunction with the accompanying drawings, in which:

FIG. 1 is a schematic diagram for describing the problems of a conventional ultrasonic inspection method;

FIG. 2 is a configuration diagram of an ultrasonic inspection apparatus according to an embodiment of the present invention;

FIG. 3(a) and FIG. 3(b) are a schematic plan diagram for describing an arrangement of a first probe and second probe applied to an ultrasonic inspection apparatus according to an embodiment of the present invention;

FIG. 4(a) and FIG. 4(b) are a schematic diagram for describing an operation of an ultrasonic inspection apparatus according to an embodiment of the present invention;

FIG. 5 is a schematic diagram for describing an operation of the first probe constituting an ultrasonic inspection apparatus according to an embodiment of the present invention;

FIG. 6 is a schematic diagram for describing an operation of the second probe constituting the ultrasonic inspection apparatus according to an embodiment of the present invention;

FIG. 7 is a schematic diagram for describing another form of the operation of the ultrasonic inspection apparatus according to an embodiment of the present invention;

FIG. 8(a), FIG. 8(b) and FIG. 8(c) are an exemplary diagram showing various scanning patterns applied to an ultrasonic inspection apparatus according to an embodiment of the present invention;

FIG. 9 is a configuration diagram of an ultrasonic inspection apparatus according to another embodiment of the present invention, which is an ultrasonic inspection apparatus for inspecting an object to be inspected formed of a plurality of layers;

FIG. 10(a) and FIG. 10(b) are an exemplary diagram of an object to be inspected to be subjected to an ultrasound inspection using an ultrasound inspection apparatus according to an embodiment of the present invention;

FIG. 11(a) and FIG. 11(b) are a schematic diagram for describing an operation of an inspection module performing ultrasound scanning on an object to be inspected of a first type using an ultrasound inspection apparatus according to an embodiment of the present invention;

FIG. 12 is a schematic diagram for describing an operation of an inspection module performing ultrasound scanning on an object to be inspected of a second type using an ultrasound inspection apparatus according to an embodiment of the present invention;

FIG. 13 is a schematic diagram for describing processing of ultrasound signals and ultrasound reflection signals applied to an ultrasound inspection apparatus according to an embodiment of the present invention;

FIG. 14 is a flowchart for describing an ultrasound inspection method using an ultrasound inspection apparatus according to an embodiment of the present invention;

FIG. 15 is a configuration diagram of an inspection stage constituting an ultrasound inspection apparatus according to an embodiment of the present invention;

FIG. 16 is an exemplary diagram of an arrangement of an ultrasound inspection apparatus according to an embodiment of the present invention;

FIG. 17(a) and FIG. 17(b) are a schematic diagram for describing an inspection method using an ultrasound inspection apparatus according to an embodiment of the present invention;

FIG. 18 is a schematic diagram for describing a process using a region division unit and region determination unit of the ultrasonic inspection apparatus according to an embodiment of the present invention; and

FIG. 19 is a schematic diagram for describing a process using a curvature information calculation unit of an ultrasonic inspection apparatus according to an embodiment of the present invention.

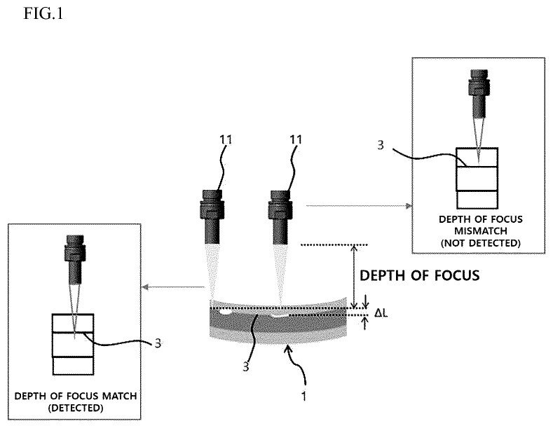

### DETAILED DESCRIPTION OF EMBODIMENTS

Hereinafter, with reference to the accompanying drawings, a preferred embodiment of the ultrasonic inspection apparatus of the present invention having the above-described problems, solutions, and effects will be described in detail.

The present invention may be modified in various ways and may have various embodiments, and thus specific embodiments will be shown in the drawings and described in detail in the detailed description. The effects and features of the present invention, and the methods for achieving them will become clear with reference to the embodiments described in detail below together with the drawings. However, the present invention is not limited to the embodiments disclosed below, and may be implemented in various forms.

Hereinafter, with reference to the accompanying drawings, embodiments of the present invention will be described in detail, and when describing with reference to the drawings, identical or corresponding components will be given the same reference numerals, and redundant descriptions thereof will be omitted.

In the following embodiments, terms such as include or have mean that a feature or component described in the specification exists, and do not preclude the possibility that one or more other features or components may be added.

In the drawings, components may be exaggerated or reduced in size for convenience of description. For example, the size and thickness of each component shown in the drawing are arbitrarily shown for convenience of description, and thus the present invention is not necessarily limited to what is shown.

When an embodiment can be implemented differently, an order of specific sequences of operations may be performed differently from the order described. For example, two operations described in succession may be performed substantially simultaneously, or may be performed in an order opposite to the order described.

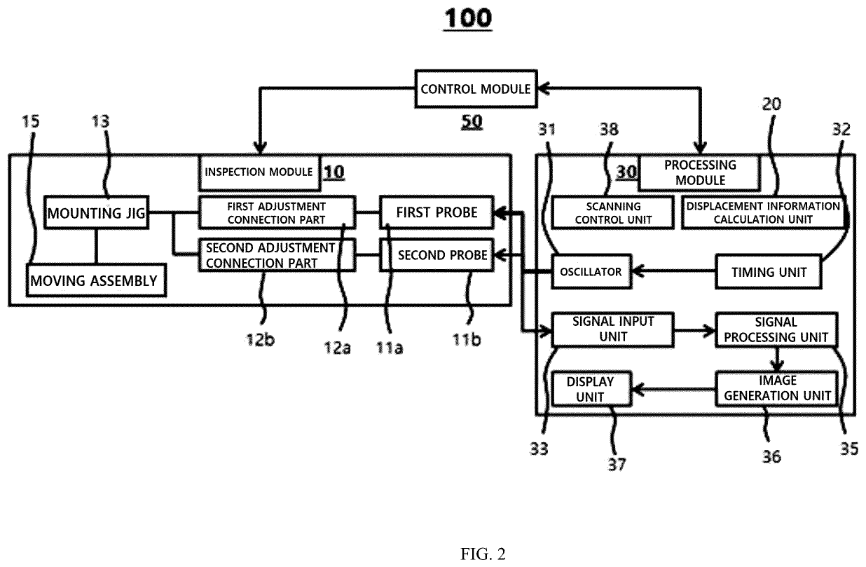

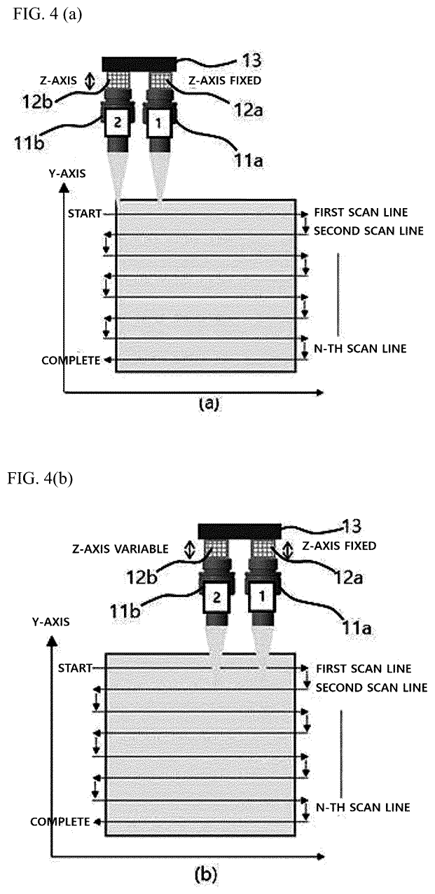

As shown in FIGS. 2 to 6, an ultrasonic inspection apparatus 100 according to the embodiment of the present invention is configured to include an inspection module 10 including a first probe 11a that performs ultrasonic scanning for calculating displacement information on an inspection surface 3 of a sample 1 and a second probe 11b that performs ultrasonic scanning for an ultrasonic inspection on the inspection surface 3 of the sample 1, a processing module 30 that transmits an ultrasonic generation signal so that each of the first probe 11a and the second probe 11b may generate an ultrasonic signal, performs gate processing on an ultrasonic reflection signal detected by the second probe 11b to output a displacement of the ultrasonic reflection signal for the inspection surface 3, and generates an image of the inspection surface 3 based on the displacement of the ultrasonic reflection signal, a displacement information calculation unit 20 that calculates displacement information corresponding to a displacement value in a height direction for a reference position of the inspection surface 3 using an ultrasonic reflection signal detected by the first probe 11a, and a control module 50 that controls an operation of the ultrasonic scanning of the inspection module 1, controls signal processing of the processing module 30, and controls the ultrasonic scanning to be performed while a height of the second probe 11b is varied based on the calculated displacement information.

The inspection module 10 includes a plurality of probes, i.e., the first probe 11a and the second probe 11b, each of which performs ultrasonic scanning on the inspection surface 3 of the sample 1. The first probe 11a applied to the present invention performs the ultrasonic scanning for calculating displacement information on the inspection surface 3 of the sample 1 under the control of the control module 50, and the second probe 11b performs ultrasonic scanning for the ultrasonic inspection on the inspection surface 3 of the sample 1 under the control of the control module 50.

The sample 1 applied to the present invention means a sample that is flexed, curved, non-flat, or non-horizontal (hereinafter referred to as a “curved sample”), and, as a result, the sample 1 has a flexed, curved, non-flat, or non-horizontal inspection surface 3. However, it is stated that the present invention is not a technology applicable only to such a curved sample, and can be applied to all types of samples.

The inspection module 10 according to the present invention is configured to further include a mounting jig 13. The mounting jig 13 performs a function of fixing the first probe 11a and the second probe 11b above a scanning position for ultrasonic scanning of the sample 1. That is, the first probe 11a and the second probe 11b are mounted and connected to a lower part of the mounting jig 13.

However, each of the first probe 11a and the second probe 11b according to the present invention is mounted so as to be adjustable in height. To this end, the inspection module 10 according to the present invention further includes a first adjustment connection part 12a and a second adjustment connection part 12b. The first adjustment connection part 12a mounts and connects the first probe 11a to the mounting jig 13 so as to be adjustable in height, and the second adjustment connection part 12b connects the second probe 11b to the mounting jig 13 so as to be adjustable in height. Therefore, the height of each of the probes 11a and 11b may be adjusted by each of the corresponding adjustment connection parts 12a and 12b.

The first adjustment connection part 12a and the second adjustment connection part 12b may adjust the height of the corresponding probes 11a and 11b under the control of the control module 50, respectively. In particular, in the present invention, the control module 50 controls the second adjustment connection part 12b so that ultrasonic scanning may be performed on the inspection surface 3 of the curved sample 1 while the height of the second probe is varied.

The inspection module 10 according to the present invention is configured to further include a moving assembly 15 that moves the mounting jig 13 so that the first probe 11a and the second probe 11b may move simultaneously. The moving assembly 15 may move the mounting jig 13 in the ±X direction, ±Y direction, and ±Z direction under the control of the control module 50. As a result, the first probe 11a and the second probe 11b that are connected to the mounting jig 13 so as to be adjustable in height may also be moved simultaneously in the ±X direction, ±Y direction, and ±Z direction.

The inspection module 10 configured in this way may generate an ultrasonic signal through the support of the processing module 30, perform ultrasonic scanning, and the ultrasonic reflection signal for the inspection surface 3 may be processed to produce displacement information and be analyzed for ultrasonic inspection.

The processing module 30 transmits an ultrasonic generation signal so that each of the first probe 11a and the second probe 11b may generate an ultrasonic signal, performs gate processing on the ultrasonic reflection signal detected by the second probe 11b to output a displacement of the ultrasonic reflection signal for the inspection surface 3, and performs an operation of generating an image for the inspection surface 3 based on the displacement of the ultrasonic reflection signal.

In addition, the processing module 30 may receive the ultrasonic reflection signal detected by the first probe 11a and transmit the ultrasonic reflection signal to the displacement information calculation unit 20 so that the displacement information may be calculated. Of course, the ultrasonic reflection signal detected by the first probe 11a may be directly transmitted to the displacement information calculation unit 20 under the control of the control module 50, so that the displacement information for the inspection surface 3 may be calculated.

To perform such an operation, the processing module 30 includes a scanning control unit 38 that controls scanning positions of the first probe 11a and the second probe 11b, includes a timing unit 32 and an oscillator 31 that transmit an ultrasonic generation signal, includes a signal input unit 33, a signal processing unit 35, and an image generation unit 36 that generate an ultrasonic image from the ultrasonic reflection signal transmitted from the second probe 11b, and includes a display unit 37 that displays the ultrasonic image.

The signal input unit 33 includes an amplifier that amplifies the ultrasonic reflection signal received by the second probe 11b, and an A/D converter that converts the ultrasonic reflection signal from analog to digital. The signal processing unit 35 detects displacement by performing gate processing on the ultrasonic reflection signal.

The scanning control unit 38 controls ultrasonic scanning under the control of the control module 50. The control module 50 controls the moving assembly 15 to control the horizontal scanning positions of the first probe 11a and the second probe 11b through X-axis driving and Y-axis driving, and transmits information of the current scanning pattern of the first probe 11a and second probe 11b to the scanning control unit 38. Then, the timing unit 32 may refer to the scanning pattern information received by the scanning control unit 38. The scanning pattern information will be described below.

The timing unit 32 outputs an ultrasonic transmission/reception timing signal (information) to the oscillator 31 based on the scanning pattern information of the first probe 11a and the second probe 11b acquired from the scanning control unit 38. The oscillator 31 outputs an ultrasonic generation signal to each of piezoelectric elements of the first probe 11a and second probe 11b based on a timing signal output by the timing unit 32.

The piezoelectric elements provided in the first probe 11a and second probe 11b have electrodes installed on both sides of a piezoelectric film thereof. The piezoelectric elements transmit ultrasonic signals from the piezoelectric film when a voltage is applied between the two electrodes. In addition, the piezoelectric elements convert an echo wave (reflected wave) received by the piezoelectric film into an ultrasonic reflection signal, which is a voltage generated between the two electrodes.

The signal input unit 33 amplifies the ultrasonic reflection signal of the second probe 11b and converts the ultrasonic reflection signal into a digital signal. The signal processing unit 35 performs signal processing on the digital ultrasonic reflection signal. The signal processing unit 35 acquires displacement information by cutting out only a predetermined period of the ultrasonic reflection signal of the second probe 11b by a gate pulse output by the timing unit 32, and outputs this displacement information to the image generation unit 36. The image generation unit 36 generates an ultrasonic image based on the displacement signal output by the signal processing unit 35. Then, the display unit 37 allows the ultrasonic image to be displayed and analyzed.

The processing module 30 also operates as a whole under the control module 50 like the inspection module 10. That is, the control module 50 performs an operation of controlling the ultrasonic scanning of the inspection module 10 and an operation of controlling the signal processing of the processing module 30.

In particular, the control module 50 controls the moving assembly 15 so that the mounting jig 13 on which the first probe 11a and the second probe 11b are mounted may operate along the X-axis, Y-axis, and Z-axis. That is, the control module 50 controls the moving assembly 15 so that the mounting jig 13 may move along the X-axis and Y-axis, thereby allowing ultrasonic scanning to be performed along a plurality of scan lines (a first scan line to an N-th scan line) for an ultrasonic inspection area of the sample 1, and controls the moving assembly 15 so that the mounting jig 13 may move along the Z-axis, thereby allowing the heights of the first probe 11a and the second probe 11b mounted on the mounting jig 13 to be adjusted as a whole.

Meanwhile, the control module 50 controls the adjustment connection parts 12a and 12b that connect the probes 11a and 11b to the mounting jig 13 so that the heights of the corresponding first probe 11a and second probe 11b may be adjusted. In particular, the second probe 11b may perform ultrasonic scanning while its height is varied based on the displacement information for a scan line of the inspection surface 3 calculated using the ultrasonic reflection signal of the first probe 11a by the control module 50 controlling the second adjustment connection part 12b. This will be described below.

The second probe 11b applied to the present invention performs ultrasonic scanning along the scan line of the inspection surface 3, but performs ultrasonic scanning while the height thereof is varied in response to the curved shape of the inspection surface 3. The height variation of the second probe 11b is controlled based on the displacement information calculated using the ultrasonic reflection signal of the first probe 11b.

To this end, the ultrasonic inspection apparatus 100 according to the present invention is configured to include the displacement information calculation unit 20 that calculates displacement information corresponding to the displacement value in the height direction for the reference position of the inspection surface 3 using the ultrasonic reflection signal detected by the first probe 11a, and the control module 50 controls ultrasonic scanning to be performed while the height of the second probe 11b is varied based on the calculated displacement information.

The control module 50 that receives the displacement information from the displacement information calculation part 20 controls the second adjustment connection part 12b based on the displacement information so that the height of the second probe 11b may be varied during an ultrasonic scanning process.

The displacement information calculation part 20 may be arranged as a separate component, may be included as a component of the processing module 30, may be provided in the signal input unit 33 of the processing module 30, or may be provided as a component of the control module 50. That is, the displacement information calculation part 20 according to the present invention is included as a component of the ultrasonic inspection apparatus 100 and performs an operation of calculating displacement information corresponding to a displacement value in the height direction for the reference position of the inspection surface 3 using the ultrasonic reflection signal detected by the first probe 11a.

The displacement information calculation unit 20 performs an operation of calculating the displacement information corresponding to the displacement value in the height direction for the reference position of the inspection surface 3 using the ultrasonic reflection signal detected by the first probe 11a under the control of the control module 50, and performs an operation of providing the calculated displacement information to the control module 50. Then, the control module 50 controls the second adjustment connection unit 12b so that the height of the second probe 11b may be varied during the ultrasonic scanning process.

The displacement information calculation unit 20 performs an operation of calculating the displacement information corresponding to the displacement value in the height direction for the reference position of the inspection surface 3 using the ultrasonic reflection signal detected by the first probe 11a.

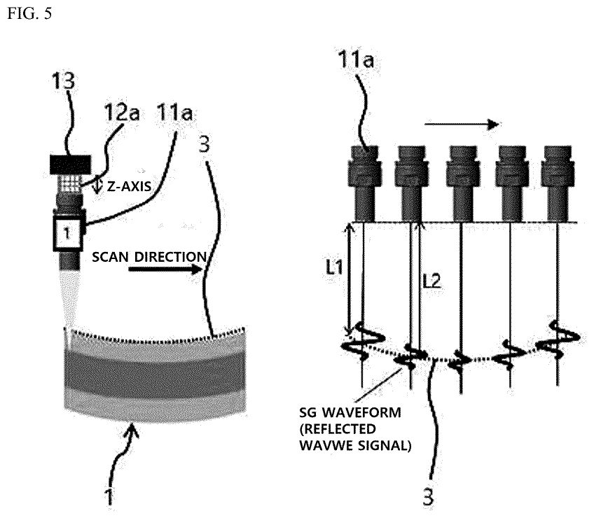

Specifically, as shown in FIG. 5, the first probe 11a performs ultrasonic scanning while moving along the scanning direction for a specific scan line of the inspection surface 3 of the sample 1 with its height fixed. The first probe 11a receives an ultrasonic reflection signal reflected from the inspection surface 3 on the scan line while performing ultrasonic scanning along the scan line and transmits the ultrasonic reflection signal to the displacement information calculation unit 20.

As the first probe 11a performs ultrasonic scanning continuously at a plurality of scanning points of the scan line, ultrasonic reflection signals reflected from the inspection surface 3 are also received corresponding to the plurality of scanning points. Since the inspection surface 3 is curved, the arrival time of the ultrasonic reflection signal at each scanning point is different.

The displacement information calculation unit 20 may calculate a separation distance L between the first probe 11a and the inspection surface 3 at each scanning point through [L=(Δt*V)/2]. Here, Δt is the time taken from oscillation of an ultrasonic wave to reception thereof, and V is the ultrasonic speed (approximately 1,480 m/sec in water).

The reference position of the inspection surface 3 means the position of the inspection surface 3 at the scanning start point (e.g., the inspection surface position having a separation distance L1 from the first probe 11a in FIG. 5). The displacement information generation unit 20 may calculate a separation distance L2 between the first probe 11a and the inspection surface 3 at the next scanning point of the scanning start point, and the displacement information at this scanning point may be calculated as the displacement value in the height direction for the reference position, i.e., a value of (L2−L1) (corresponds to the height difference of the inspection surface at the two scanning points) as displacement information.

Through this process, the displacement information calculation unit 20 may calculate the displacement information along the scan line of the inspection surface 3, and provides the calculated displacement information to the control module 50. Then, the control module 50 controls the ultrasonic scanning to be performed while the height of the second probe 11b is varied based on the displacement information.

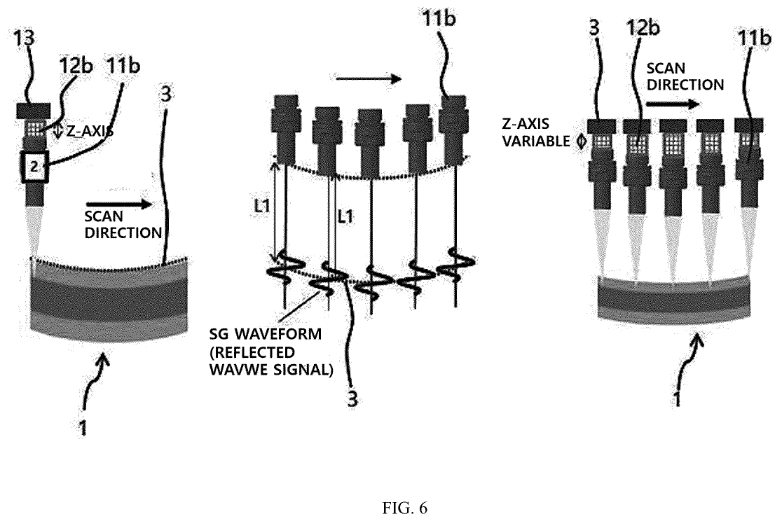

Specifically, the control module 50 controls the second adjustment connection part 12b so that the height of the second probe 11b may be corrected during the ultrasonic scanning process of the second probe 11b in response to the displacement information. As a result, as shown in FIG. 6, the second probe 11b may perform ultrasonic scanning while its height is varied in response to the curved shape of the inspection surface of the scan line mapped using the displacement information calculated by the displacement information calculating part 20 during the ultrasonic scanning process.

During the ultrasonic scanning process, the separation distance L1 between the second probe 11b and the inspection surface 3 becomes the same at all scanning points. As a result, if ultrasonic scanning is performed after focusing of the second probe 11b is performed at the reference position, ultrasonic scanning may be performed in a focused state at all scanning points, and thus high-precision ultrasonic inspection may be performed.

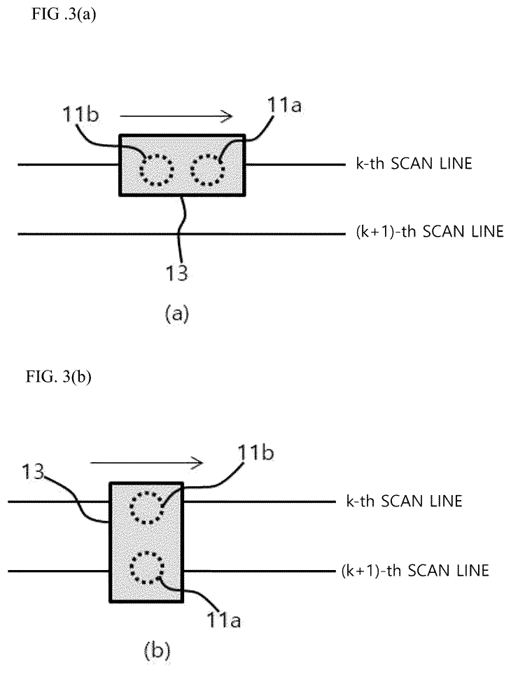

Meanwhile, as shown in FIG. 3, the first probe 11a and the second probe 11b applied to the present invention are mounted and connected to the mounting jig 13, but are mounted and connected in a longitudinal arrangement form in which, the first probe 11a and the second probe 11b arranged in a row along the same scan line ((a) of FIG. 3), or in a transverse arrangement form in which, the first probe 11a and the second probe 11b arranged one by one along adjacent scan lines ((b) of FIG. 3).

(a) of FIG. 3 illustrates that the first probe 11a and the second probe 11b are mounted and connected to the mounting jig 13 in a form in which they arranged in a row along a k-th scan line, i.e., in the longitudinal arrangement form when the first probe 11a and the second probe 11b perform ultrasonic scanning along a specific scan line, e.g., the k-th scan line, and (b) of FIG. 3 illustrates that the first probe 11a and the second probe 11b are mounted and connected to the mounting jig 13 in a form in which they are arranged one by one across different adjacent scan lines, e.g., a k-th scan line and a (k+1)-th scan line, that is, in the transverse arrangement form crossing the scan line.

As shown in (a) of FIG. 3, when the first probe 11a and the second probe 11b are mounted and connected to the mounting jig 13 in the longitudinal arrangement form, the control module 50 controls ultrasonic scanning to be performed for the (k+1) scan line corresponding to the next scan line of the specific scan line while the height of the second probe 11b is varied based on the displacement information calculated using the ultrasonic reflection signal detected by the first probe 11a for a specific scan line, e.g., the k-th scan line.

That is, the control module 50 performs control so that ultrasonic scanning is performed for a specific scan line by the first probe 11a, and the displacement information calculation unit 20 analyzes the ultrasonic reflection signal reflected back to the inspection surface 3 to calculate displacement information for the specific scan line, and then performs control so that the height of the second probe 11b may be varied when the second probe 11b performs ultrasonic scanning for another scan line of the specific scan line in response to the displacement information produced.

As a result, when the second probe 11b performs scanning for ultrasonic inspection on a given scan line, the second probe 11b performs ultrasonic scanning while its height is varied in response to the curved shape of the inspection surface 3 of the previous scan line. Therefore, the arrangement form of (a) of FIG. 3 has a limitation in that it can guarantee ultrasonic inspection accuracy only when the spacing between adjacent scan lines is close or shapes of the inspection surfaces 3 of adjacent scan lines are almost the same.

Meanwhile, in this case, the control module 50 performs control so that, when the second probe 11b performs ultrasonic scanning for the (k+1)-th scan line while the height of the second probe 11b is varied, the first probe 11a performs ultrasonic scanning for calculating displacement information for the (k+1)-th scan line, and the displacement information calculation unit 20 calculates displacement information using the ultrasonic reflection signal detected for the (k+1)-th scan line.

As a result, the control module 50 may control the second adjustment connection part 12b so that, when the second probe 11b performs ultrasonic scanning on a (k+2)-th scan line by reflecting the displacement information for the (k+1)-th scan line calculated by the displacement information calculating unit 20, ultrasonic scanning may be performed while the height thereof is varied in response to displacement information for the (k+1)-th scan line. If this process is repeated, the second probe 11b may perform ultrasonic inspection while the height thereof is varied in response to the shape of the inspection surface 3 of the previous scan line for all scan lines of the inspection surface 3, and as a result, an ultrasonic inspection with guaranteed accuracy may be performed.

As shown in (b) of FIG. 3, when the first probe 11a and the second probe 11b are mounted and connected to the mounting jig 13 in the horizontal arrangement form, the control module 50 performs control so that ultrasonic scanning is performed for the k-th scan line corresponding to the scan line for which displacement information is to be calculated while the height of the second probe 11b is varied based on the displacement information calculated using the ultrasonic reflection signal detected by the first probe 11a for a specific scan line, e.g., the k-th scan line.

That is, the control module 50 performs control so that ultrasonic scanning is performed for a specific scan line by the first probe 11a, and the displacement information calculation unit 20 analyzes the ultrasonic reflection signal reflected back to the inspection surface 3 to calculate displacement information for the specific scan line, and then the height thereof may be varied when the second probe 11b performs ultrasonic scanning for the same specific scan line in response to the calculated displacement information.

As a result, when the second probe 11b performs scanning for ultrasonic inspection on a specific scan line, the second probe 11b performs ultrasonic scanning while the height thereof is varied in response to the curved shape of the inspection surface 3 of the previous scan line. Therefore, in the arrangement form of (b) of FIG. 3, the accuracy of ultrasonic inspection may be further improved compared to the arrangement form of (a) of FIG. 3.

Meanwhile, in this case, the control module 50 performs control so that, when the second probe 11b performs ultrasonic scanning for the k-th scan line while the height thereof is varied, the first probe 11a performs ultrasonic scanning for calculating displacement information for the (k+1)-th scan line, and the displacement information calculation unit 20 calculates displacement information using the ultrasonic reflection signal detected for the (k+1)-th scan line.

As a result, the control module 50 may control the second adjustment connection part 12b so that ultrasonic scanning may be performed while the height thereof is varied in response to displacement information for the (k+1)-th scan line when the second probe 11b performs ultrasonic scanning of the (k+1)-th scan line corresponding to the same scan line by reflecting the displacement information for the (k+1)-th scan line calculated by the displacement information calculating unit 20. If this process is repeated, the second probe 11b may perform ultrasonic inspection while the height thereof is varied in response to the shape of the inspection surface 3 of the previous scan line for all scan lines of the inspection surface 3, and as a result, an ultrasonic inspection may be performed with greatly improved and guaranteed accuracy.

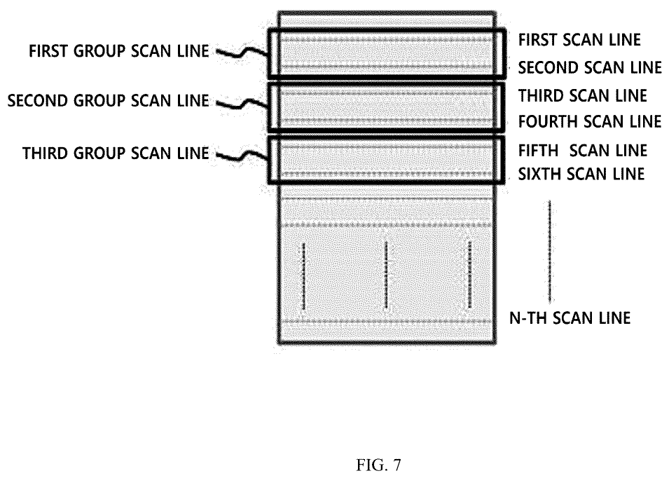

Meanwhile, as shown in FIG. 7, the control module 50 according to the present invention may perform control so that the first probe 11a performs ultrasonic scanning for displacement information calculation continuously for a plurality of scan lines, and the second probe 11b performs ultrasonic scanning for ultrasonic inspection on the inspection surface of the sample continuously for a plurality of scan lines while the height thereof is varied.

For example, the control module 50 may define a first scan line and a second scan line as a first group scan line by grouping them, a third scan line and a fourth scan line as a second group scan line by grouping them, a fifth scan line and sixth scan line as a third group scan line by grouping them, etc., and control the ultrasonic scanning operation by the first probe 11a and the ultrasonic scanning operation by the second probe 11b to be performed for each group scan line. Such a case is preferably applied when the scan lines are formed very close to each other or have a slight degree of curvature thereof and are almost horizontal.

According to the ultrasonic inspection apparatus according to an embodiment of the present invention described above, since the present invention has a configuration in which the first probe which performs ultrasonic scanning for calculating displacement information on the inspection surface of the sample and the second probe which performs ultrasonic scanning for the ultrasonic inspection on the inspection surface of the sample are included and ultrasonic scanning is performed while the height of the second probe is varied based on displacement information calculated using the ultrasonic reflection signal detected by the first probe, an advantage of being able to perform rapid and highly precise ultrasonic inspection even on a sample with a non-flat or non-horizontal inspection surface, such as a curved sample occurs.

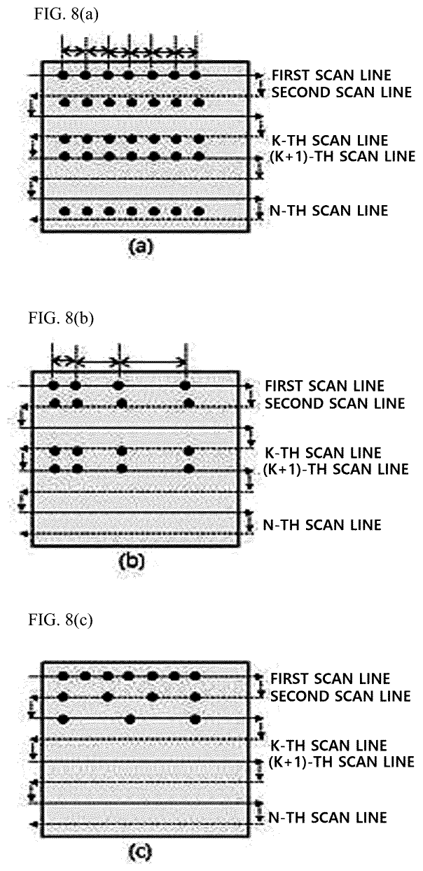

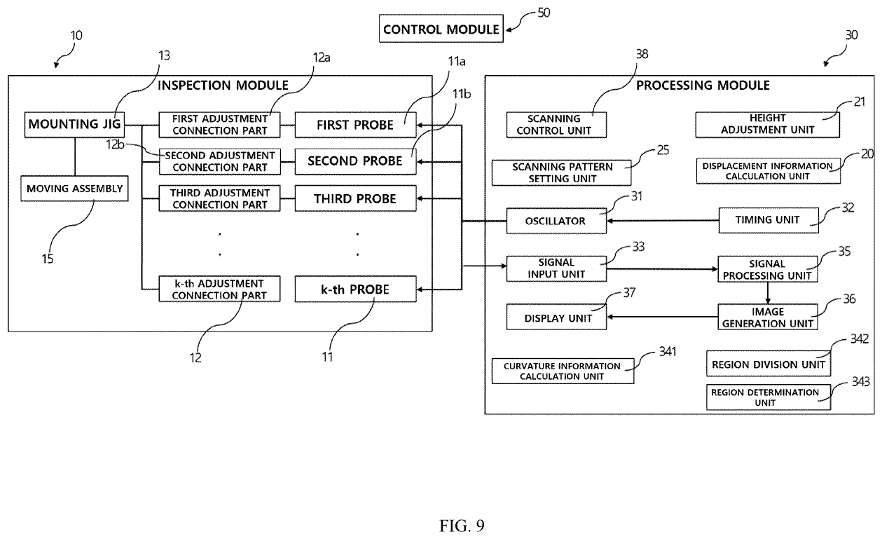

FIG. 8 is an exemplary diagram showing various scanning patterns applied to an ultrasonic inspection apparatus according to an embodiment of the present invention. Description will be made with reference to FIGS. 8 and 9 together. The ultrasonic inspection apparatus 100 according to the present invention is configured to include a scanning pattern setting unit 25 that stores and manages a scanning pattern corresponding to separation information between the scanning points for each scan line of the first probe 11a and the second probe 11b.

The scanning pattern may be varied by an administrator and may be variably applied to each sample having a different degree of curvature. Accordingly, in the scanning pattern setting unit 25, the scanning pattern may be stored and managed by changing the scanning pattern into a different scanning pattern as needed by the administrator.

The first probe 11a and the second probe 11b perform ultrasonic scanning while moving along a plurality of scan lines (first scan line to N-th scan line) during the process of performing ultrasonic scanning on the sample, and perform ultrasonic scanning for each of scanning points corresponding to the scanning pattern stored and managed in the scanning pattern setting unit 25 under the control of the control module 50.

The scanning pattern may be variably set by the administrator according to the curved shape, the degree of curvature that is different for each part of the sample 1, etc. Specifically, as shown in FIG. 8, the scanning points (represented by dots) in each scan line forming the scanning pattern may be separated from each other at equal intervals (as exemplified in (a) of FIG. 8) or separated from each other at different intervals (as exemplified in (b) of FIG. 8). In addition, the respective scan lines may have the same scanning pattern as shown in (a) and (b) of FIG. 8, or may have different scanning patterns as shown in (c) of FIG. 8.

That is, the scanning patterns applied to the present invention may be formed such that the scanning patterns of the scan lines are the same and the intervals between the scanning points in each scan line are the same, as shown in (a) of FIG. 8, or the scanning patterns of the scan lines are the same and the intervals between the scanning points in each scan line are different as shown in (b) of FIG. 8, or the scanning patterns of the scan lines may be different from each other and the intervals between the scanning points in each scan line may be formed differently as shown in (c) of FIG. 8.

These scanning patterns are stored and managed in the scanning pattern setting unit 25, and the scanning pattern setting unit 25 transmits scanning pattern information about the first probe 11a and the second probe 11b to the scanning control unit 38 under the control of the control module 50. Then, the timing unit 32 may refer to the scanning pattern information received by the scanning control unit 38.

Hereinafter, with reference to FIGS. 9 to 14, ultrasound scanning of an object to be inspected formed of a plurality of layers using an ultrasound inspection apparatus according to an embodiment of the present invention will be described. FIG. 9 is a configuration diagram of an ultrasound inspection apparatus according to another embodiment of the present invention, for inspecting an object to be inspected formed of plurality of layers. In the following, description will be made based on FIG. 9.

As shown in FIGS. 9 to 14, an ultrasonic inspection apparatus 100 according to the embodiment of the present invention is configured to include an inspection module 10 including a plurality of probes 11 each of which performs ultrasonic scanning corresponding to each of a plurality of bonding surfaces 5 of an object to be inspected 1 formed of a plurality of layers 3, a processing module 30 that transmits an ultrasonic generation signal so that each of the plurality of probes 11 may generate an ultrasonic signal, performs gate processing on the ultrasonic reflection signal detected by each of the plurality of probes 11 and outputs a displacement of the ultrasonic reflection signal for each of the plurality of bonding surfaces 5, and generates an image for each bonding surface 5 based on the displacement of each of ultrasonic reflection signal, and a control module 50 that controls an operation of the ultrasonic scanning of the inspection module 10 and controls signal processing of the processing module 30.

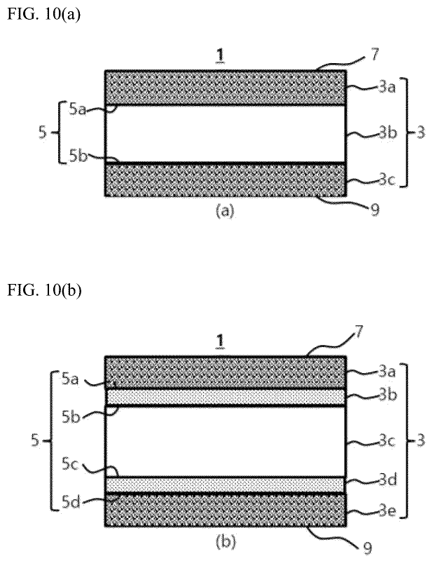

The inspection module 10 includes the plurality of probes 11 each of which performs ultrasonic scanning corresponding to each of the plurality of bonding surfaces 5 of the object to be inspected 1 formed of the plurality of layers 3. That is, as shown in FIG. 9, the inspection module 10 according to the present invention includes a first probe to a k-th probe 11, and these probes perform ultrasonic scanning in sequence corresponding to a first bonding surface to a k-th bonding surface 5 of the object to be inspected 1 (see FIG. 10).

The object to be inspected 1 applied to the present invention may be formed of sequentially laminating and bonding a first layer 3a, a second layer 3b, and a third layer 3c, as shown in (a) of FIG. 10, and a first bonding surface 5a is formed at a boundary surface of the first layer 3a and the second layer 3b and a second bonding surface 5b is formed at a boundary surface of the second layer 3b and the third layer 3c. The object to be inspected 1 has an upper surface 7 corresponding to a top surface of the first layer 3a, which is the uppermost layer, and a lower surface 9 corresponding to a lower surface of the third layer 3c, which is the lowermost layer.

Such an object to be inspected 1 may be a direct copper bonding (DCB) substrate corresponding to a power semiconductor module substrate. In this case, the second layer 3b may be a ceramic substrate (e.g., Al₂O₃, AlN, Si₃N₄, zirconia-doped alumina (ZDA)), and the first layer 3a and the third layer 3c may be an upper metal layer (e.g., Cu or Al) and a lower metal layer (e.g., Cu or Al) of the ceramic substrate, respectively.

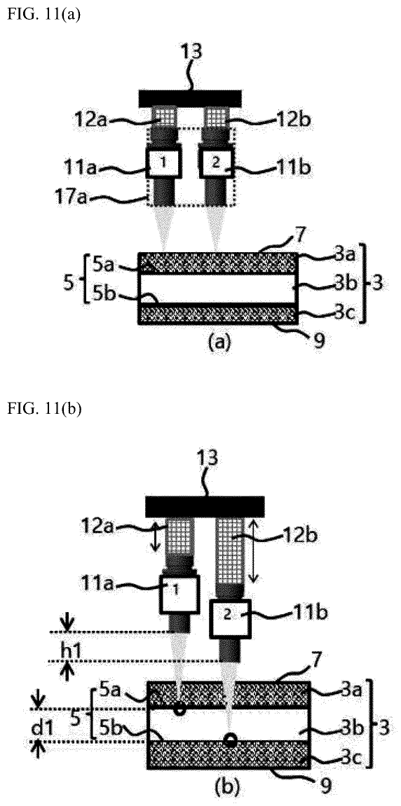

In order to perform an ultrasonic inspection on the object to be inspected 1 corresponding to the DCB substrate as shown in (a) of FIG. 10, the inspection module 10 may include a first probe 11a that performs ultrasonic scanning corresponding to a first bonding surface 5a and a second probe 11b that performs ultrasonic scanning corresponding to a second bonding surface 5b, as shown in FIG. 11. That is, in this case, the inspection module 10 may include two probes 11a and 11b each of which performs ultrasonic scanning on each of corresponding bonding surfaces 5a and 5b.

In addition, as shown in (b) of FIG. 10, the object to be inspected 1 applied to the present invention may be formed of sequentially laminating and bonding a first layer 3a, a second layer 3b, a third layer 3c, a fourth layer 3d, and a fifth layer 3e, and a first bonding surface 5a is formed at a boundary surface of the first layer 3a and the second layer 3b, a second bonding surface 5b is formed at a boundary surface of the second layer 3b and the third layer 3c, a third bonding surface 5c is formed at a boundary surface of the third layer 3c) and the fourth layer 3d, and a fourth bonding surface 5d is formed at a boundary surface of the fourth layer 3d and the fifth layer 3e. The object to be inspected 1 has an upper surface 7 corresponding to the top surface of the first layer 3a, which is the uppermost layer, and a lower surface 9 corresponding to a lower surface of the fifth layer 3e), which is the lowermost layer.

Such an object to be inspected 1 may be an active metal brazing (AMB) substrate corresponding to a high voltage power semiconductor module substrate. In this case, the third layer 3c may be a ceramic substrate (e.g., Al₂O₃, AlN, Si₃N₄, zirconia-doped alumina (ZDA)), and the first layer 3a and fifth layer 3e may be an upper metal layer (e.g., Cu or Al) and a lower metal layer (e.g., Cu or Al) of the ceramic substrate, respectively, and the second layer 3b and fourth layer 3d may be metal brazing layers.

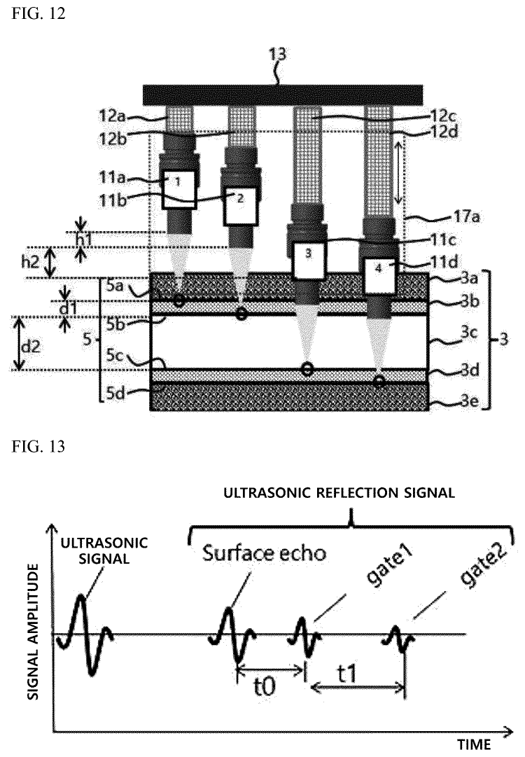

In order to perform an ultrasonic inspection on the object to be inspected 1 corresponding to the AMB substrate as shown in (b) of FIG. 10, as shown in FIG. 12, the inspection module 10 may include a first probe 11a that performs ultrasonic scanning corresponding to the first bonding surface 5a, a second probe 11b that performs ultrasonic scanning corresponding to the second bonding surface 5b, a third probe 11c that performs ultrasonic scanning corresponding to the third bonding surface 5c, and a fourth probe 11d that performs ultrasonic scanning corresponding to the fourth bonding surface 5d. That is, in this case, the inspection module 10 may include four probes 11a to 11d each of which performs ultrasonic scanning on each of the corresponding bonding surface 5a to 5d.

The inspection module 10 according to the present invention is configured to further include a mounting jig 13. The mounting jig 13 performs a function of fixing a plurality of probes 11 above the inspection position for ultrasonic inspection of the object to be inspected 1. As shown in FIGS. 11 and 12, a plurality of probes 11 are mounted below the mounting jig 13.

However, each of the plurality of probes 11 according to the present invention is mounted so as to be adjustable in height so that it may be focused on the corresponding bonding surface 5. To this end, the inspection module 10 according to the present invention further includes a plurality of adjustment connection parts 12. Each adjustment connection part 12 connects the corresponding probe 11 to the mounting jig 13 so that height adjustment thereof is possible. Therefore, the height of each probe 11 may be adjusted by the corresponding adjustment connection part 12.

The adjustment connection part may be composed of a first adjustment connection part to a k-th adjustment connection part 12 so as to be made to correspond to a first probe to a k-th probe 11, respectively, and each adjustment connection part may adjust the height of the corresponding probe 11 under the control of the control module 50.

In particular, the control module 50 controls the moving assembly 15 so that the mounting jig 13 on which the plurality of probes 11 are mounted may operate in the X-axis, Y-axis, and Z-axis. That is, the control module 50 controls the moving assembly 15 to allow the mounting jig 13 to move in the X-axis and Y-axis, thereby allowing ultrasonic scanning to be performed on an ultrasonic inspection area of the object to be inspected 1, and controls the moving assembly 15 to allow the mounting jig 13 to move along the Z-axis, thereby allowing the height of the plurality of probes 11 mounted on the mounting jig 13 to be adjusted as a whole.

Meanwhile, the control module 50 controls each adjusting connection part 12 that connects each probe 11 to the mounting jig 13 so as to be adjustable in height so that the height of each corresponding probe 11 may be adjusted. Through this, each probe 11 may be focused on the corresponding bonding surface 5. This will be described below.

The ultrasonic inspection apparatus 100 according to the present invention includes a plurality of probes 11 so that each of the plurality of probes 11 may perform ultrasonic scanning corresponding to each of the plurality of bonding surfaces 5 of the object to be inspected 1 formed of the plurality of layers 3. Therefore, each probe 11 needs to be focused on the corresponding bonding surface 5 before ultrasonic scanning is performed.

The plurality of probes 11 applied to the present invention emits ultrasonic signals of the same frequency to scan the corresponding bonding surface 5, and each ultrasonic reflection signal corresponding to an echo signal for the ultrasonic signal of each probe 11 is subjected to gate processing by the processing module 30 so that the displacement of the ultrasonic reflection signal for the corresponding bonding surface 5 may be output.

The present invention has a configuration in which each probe 5 may be focused on each corresponding bonding surface 5 in order to improve the accuracy and precision of ultrasonic inspection for each bonding surface 5, and, to this end, the probe 11 is configured to be adjusted in height so that it may be focused on the corresponding bonding surface 5.

To this end, the ultrasonic inspection apparatus 100 according to the present invention is configured to further include a height adjustment unit 21 that calculates a height adjustment value for each probe 11 and provides it to the control module 50 so that focusing of each probe 11 may be performed on each corresponding bonding surface 21.

The control module 50 that receives the height adjustment value from the height adjustment part 21 may control the moving assembly 15 to adjust the height of the probe 11 mounted on the mounting jig 13 or control each adjustment connection part 12 to adjust the height of each corresponding probe 11.

The height adjustment unit 21 may be arranged as a separate component, may be provided as a component of the processing module 30, may be provided in the signal input unit 33 of the processing module 30, and may be provided as a component of the control module 50. That is, the height adjustment unit 21 according to the present invention is included as a component of the ultrasonic inspection apparatus 100 and performs an operation of calculating a height adjustment value for each probe 11 that allows enables each probe 11 to be focused on each corresponding bonding surface.

The height adjustment unit 21 performs an operation of calculating the height adjustment value for each probe 11 that allows each probe 11 to be focused on each corresponding bonding surface 5 under the control of the control module 50, and performs an operation of providing the calculated height adjustment value to the control module 50. The control module 50 controls the moving assembly 15, especially each adjustment connection unit 12, so that the height of the corresponding probe 11 may be adjusted.

The height adjustment unit 21 may calculate the height adjustment value for each probe 11 using various height adjustment value calculation methods under the control of the control module 50 and provide the calculated height adjustment value to the control module 50. Hereinafter, the various height adjustment value calculation methods of the height adjustment unit 21 will be described in detail.

The height adjustment unit 21 may calculate the height adjustment value by a first height adjustment value calculation method and provide the height adjustment value to the control module 50. That is, the height adjustment unit 21 may perform an operation of providing height corresponding information of each probe 11, at which the displacement of the ultrasonic reflection signal for each bonding surface 5 corresponding to each probe 11 is maximized, as the height adjustment value to the control module 50.

Here, the height corresponding information corresponds to a height value of the probe 11, which is a target of focusing, provided by the control module 50 or height value identification information corresponding to this height value or identification information of the probe 11 which is a target of focusing.

When the first height adjustment value calculation method is applied, the control module 50 allows A-scan to be sequentially performed for each probe 11 corresponding to each bonding surface 5 so that the height adjustment unit 21 may determine height corresponding information at which the displacement of the ultrasonic reflection signal for each bonding surface 5 corresponding to each probe 11 is maximized.

In the A-scan, the size (amplitude) of the ultrasonic reflection signal received for a point in the vertical direction of the object to be inspected 1 is expressed for time, thereby determining the defect of the object to be inspected. Specifically, as shown in FIG. 13, a waveform of an echo signal for the time side, i.e., a waveform of the ultrasonic reflection signal may be displayed using each probe 11, and the vertical side of the graph is configured to represent the strength (amplitude) of the signal, and the horizontal side thereof to represent time. That is, it is a method of checking the change in amplitude over time from a specific reference point. In this case, ultrasonic focusing may be performed in a way of moving the Z-axis height of each probe 11 minutely to secure the maximum amplitude for the corresponding bonding surface 5.

In the A-scan, each probe 11 emits the ultrasonic signal to the object to be inspected 1 in the vertical direction. In this case, it is configured to adjust a focusing distance having the maximum amplitude for the corresponding bonding surface 5 of the object to be inspected 1. After that, a gate is set before and after the ultrasonic reflection signal of the corresponding bonding surface 5. The gate is used to limit a region to be inspected to a certain section. Here, the focusing distance may be adjusted through the Z-axis movement by the control module 50 controlling the adjustment connection part 12 corresponding to the probe 11 that performs the A-scan.

The first height adjustment value calculation method will be described in more detail with reference to FIG. 11 as follows.

The control module 50 controls the first probe 11a corresponding to the first bonding surface 5a to perform A-scan while the height thereof is varied. That is, the control module 50 controls the first adjustment connection part 12a corresponding to the first probe 11a so that the height of the first probe 11a may be varied, and controls the first probe 11a to emit an ultrasonic signal at each varied height.

Each echo signal for the ultrasonic signal at each of the varied heights, i.e., each ultrasonic reflection signal, is received by the first probe 11a and sequentially transmitted to the height adjustment part 21. The height adjustment unit 21 may form the A-scan waveform shown in FIG. 13 and analyze it to determine a corresponding ultrasonic reflection signal having the maximum amplitude (displacement) at the corresponding first bonding surface 5a. As a result, the height adjustment unit 21 may determine a variable height of the first probe 11a that receives the corresponding ultrasonic reflection signal.

When the control module 50 controls the first probe 11a to emit the ultrasonic signal at a specific variable height, the control module 50 also transmits the specific variable height to the height adjustment unit 21. As a result, the height adjustment unit 21 may match and store the A-scan waveform analysis results corresponding to each variable height of the first probe 11a. Through this, the height adjustment unit 21 may determine the variable height of the first probe 11a that receives the corresponding ultrasonic reflection signal having the maximum amplitude (displacement) at the first bonding surface 5a according to the A-scan waveform analysis results.

The height adjustment unit 21 transmits the variable height of the first probe 11a as a height adjustment value to the control module 50. Then, the control module 50 controls the first adjustment connection unit 12a so that the first probe 11a may be adjusted to the variable height. Then, the first adjustment connection unit 12 adjusts the height of the first probe 11a to the variable height. As a result, focusing of the first probe 11a on the corresponding first bonding surface 5a is completed, so that the precision of the ultrasonic inspection may be improved through subsequent ultrasonic scanning.

When the focusing of the first probe 11a on the first bonding surface 5a is completed under the control of the control module 50 and the operation of the height adjustment unit 21, the focusing of the second probe 11b on the second bonding surface 5b may be performed through the same control and operation as above.

If, as shown in FIG. 12, the object to be inspected 1 includes four probes 11 corresponding to four bonding surfaces 5a to 5d, the control of the control module 50 and the operation of the height adjustment unit 21 are applied in the same manner so that focusing of the third probe 11c on the third bonding surface 5c and focusing of the fourth probe 11d on the fourth bonding surface 5d may be performed.

Meanwhile, unlike the first height adjustment value calculation method, the height adjustment unit 21 may calculate a height adjustment value by a second height adjustment value calculation method and provide the height adjustment value to the control module 50. That is, the height adjustment unit 21 performs an operation of providing the height corresponding information of a specific probe 11, of which the displacement of the ultrasonic reflection signal for the specific bonding surface 5 corresponding to the specific probe 11 is maximized, as the height adjustment value for the specific probe 11 to the control module 50 (hereinafter, referred to as “A-scan-based focusing operation”), and then an operation of calculating the thickness of each layer 3 of the object to be inspected 1 through the time difference of the ultrasonic reflection signal for each bonding surface 5 to calculate a separation distance between the specific bonding surface 5 and other bonding surfaces 5, and then an operation of providing the calculated separation distances as the height adjustment values for each of other probes 11 to the control module 50 (hereinafter, referred to as “separation distance-based focusing operation”).

Referring to FIG. 11 again, the second height adjustment value calculation method will be described in detail as follows.

First, the “A-scan-based focusing operation” is performed for the first probe 11a corresponding to a specific probe. That is, the height corresponding information of a specific probe, i.e., the first probe 11a, of which the displacement of the ultrasonic reflection signal for a specific bonding surface corresponding to the first probe 11a, which corresponds to the specific probe, i.e., the first bonding surface 5a, is maximized is provided to the control module 50 as the height adjustment value for the specific probe, i.e., the first probe 11a. This “A-scan-based focusing operation” follows the operation of calculating the height adjustment value through the A-scan under the control and operation of the control module 50 and the height adjustment unit 21 described in the first height adjustment value calculation method described above.

When the height of the first probe 11a is adjusted according to the “A-scan-based focusing operation”, the height adjustment unit 21 calculates a height adjustment value for the second probe 11b corresponding to another probe according to the “separation distance-based focusing operation”, and provides the height adjustment value to the control module 50.

Specifically, the height adjustment unit 21 calculates the thickness of each layer of the object to be inspected 1, particularly the second layer 3b, using the ultrasonic reflection signal used when determining the height adjustment value for the first probe 11a through the “A-scan based focusing operation” to calculate a separation distance between the second bonding surface 5b corresponding to the second probe 11b and the specific bonding surface, i.e., the first bonding surface 5a. Here, the separation distance between the second bonding surface 5b corresponding to the second probe 11b and the specific bonding surface, i.e., the first bonding surface 5a, ultimately corresponds to the thickness of the second layer 3b.

The height adjustment unit 21 may calculate a thickness d1 of the second layer 3b through a time difference between the ultrasonic reflection signals for the specific bonding surface, i.e., the first bonding surface 5a, and the second bonding surface 5b corresponding to the second probe 11b. That is, the height adjustment unit 21 may calculate a time difference t1 between the ultrasonic reflection signals for the first bonding surface 5a and the second bonding surface 5b through the ultrasonic reflection signal waveform.

The height adjustment unit 21 may calculate the thickness of the second layer 3b, i.e., the separation distance between the first bonding surface 5a and the second bonding surface 5b through various distance calculation methods using the calculated time difference t1 between the ultrasonic reflection signals for the first bonding surface 5a and the second bonding surface 5b. For example, since the height adjustment unit 21 stores and manages a medium constituting each layer of the object to be inspected 1 and an ultrasonic velocity for each medium in advance, the thickness of the second layer 3b, i.e., the separation distance between the first bonding surface 5a and the second bonding surface 5b may be calculated through (ultrasonic velocity for the medium of second layer 3b)*(t½).

The height adjustment unit 21 provides the calculated thickness of the second layer 3b, i.e., the separation distance between the first bonding surface 5a and the second bonding surface 5b as a height adjustment value for another probe, i.e., the second probe 11b, to the control module 50. Then, the control module 50 determines the provided height adjustment value as a height displacement value h1 of the second probe 11b for the first probe 11a, and controls the second adjustment connection part 12b so that the second probe 11b may move with a height difference of the height displacement value h1 with respect to the first probe 11a. According to this “separation distance-based focusing operation”, the second probe 11b may be focused on the corresponding second bonding surface 5b, thereby improving the precision of the ultrasonic inspection.

The height adjustment unit 21 uses and analyzes the ultrasonic reflection signal to determine the time difference for calculating the thickness of each layer 3 in the process of performing the “separation distance-based focusing operation”, and the ultrasonic reflection signal used and analyzed in this case is preferably an ultrasonic reflection signal, which is an echo signal for the ultrasonic signal of the probe, i.e., the first probe 11a, of which focusing is completed according to the “A-scan-based focusing operation”. Since focusing is completed for the first probe, the amplitude of the ultrasonic reflection signal for the first bonding surface 5a is maximized and consequently the amplitude of the ultrasonic reflection signal for an adjacent another bonding surface, i.e., the second bonding surface 5b, is also sufficiently large, and accordingly, it is possible to prevent in advance the case where the time difference cannot be determined due to the absence or minimum of the reflection signal.

When the second height adjustment value calculation method described above is applied to the object to be inspected as shown in FIG. 12, the height adjustment unit 21 determines the time difference of the ultrasonic reflection signal between the second bonding surface 5b and the third bonding surface 5c and between the third bonding surface 5c and the fourth bonding surface 5d to calculate a thickness d2 of the third layer 3c of the object to be inspected 1 and the thickness (not shown) of the fourth layer 3d in the process of the “separation distance-based focusing operation”. The height adjustment unit 21 may calculate the separation distance between the first bonding surface 5a and the third bonding surface 5c and the separation distance between the first bonding surface 5a and the fourth bonding surface 5d through the thickness of each layer, and provides the calculated separation distances as a height displacement value (height displacement value h2) for the third probe 11c and a height adjustment value for the fourth probe 11d, i.e., height displacement value for the first probe 11a to the control module 50, respectively.

Then, the control module 50 controls the corresponding third adjustment connection part and the fourth adjustment connection part so that the third probe and the fourth probe are separated by the determined height displacement values from the first probe, respectively. As a result, the third probe 11c is focused on the corresponding third joint 5c and the fourth probe 11d is focused on the corresponding fourth joint 5d, thereby improving the precision of the ultrasonic inspection.

Meanwhile, the height adjustment unit 21 may calculate a height adjustment value by a third height adjustment value calculation method, which is different from the first height adjustment value calculation method and the second height adjustment value calculation method, and provide the height adjustment value to the control module 50. That is, the height adjustment unit 21 provides the height correspondence information of a specific probe 11, of which the displacement of the ultrasonic reflection signal for a specific bonding surface 5 corresponding to the specific probe 11 is maximized, as the height adjustment value for the specific probe 11 to the control module 20 (“A-scan based focusing operation”), and then sequentially calculates the height adjustment value from another bonding surface 5 located close to the specific bonding surface 5 to another bonding surface 5 located far from the specific bonding surface 5 for each different probe 11 corresponding to each different bonding surface 5 in order and provides the height adjustment value to the control module 50. The height adjustment value for the specific different probe 11 is determined by calculating the separation distance between the corresponding another specific bonding surface 5 and the immediately previous bonding surface 5 corresponding to the immediately previous probe 11 of which height adjustment value calculation is completed immediately before (hereinafter, referred to as “sequential adjustment-based focusing operation”).

Referring to FIG. 12 again, the third height adjustment value calculation method will be described in detail as follows.

First, the “A-scan-based focusing operation” is performed for the first probe 11a which corresponds to the specific probe. That is, the height correspondence information of the specific probe, i.e., the first probe 11a, of which the displacement of the ultrasonic reflection signal for the specific bonding surface corresponding to the first probe 11a, which corresponds to the specific probe, i.e., the first bonding surface 5a, is maximized, is provided to the control module 50 as the height adjustment value for the specific probe, i.e., the first probe 11a. This “A-scan-based focusing operation” follows the operation of calculating the height adjustment value through A-scan under the control and operation of the control module 50 and the height adjustment unit 21 described in the first height adjustment value calculation method and second height adjustment value calculation method described above.

When the height of the first probe 11a is adjusted according to the “A-scan-based focusing operation”, the height adjustment unit 21 calculates the height adjustment value for the second probe 11b to the fourth probe 4d corresponding to other probes according to the “sequential adjustment-based focusing operation” and provides the height adjustment values to the control module 50.

Specifically, the height adjustment unit 21 sequentially calculates the height adjustment values for respective different probes 11b, 11c, and 11d corresponding to respective different bonding surfaces 5b, 5c, and 5d from the second bonding surface 5b, which corresponds to another bonding surface and is located close to the first bonding surface 5a, which corresponds to a specific bonding surface, to the fourth bonding surface 5d, which corresponds to another bonding surface and is located far away from the first bonding surface 5a, in order and provides the height adjustment values to the control module 50.

Therefore, the height adjustment unit 21 first calculates the height adjustment value for a specific other probe, i.e., the second probe 11b, corresponding to the second bonding surface 5b, which corresponds to another bonding surface located closest to the first bonding surface 5a. The height adjustment value for the second probe 11b, which corresponds to the specific other probe, is determined by calculating the separation distance between the corresponding another specific bonding surface, i.e., the second bonding surface 5b, and the immediately previous bonding surface, which corresponds to the previous probe, i.e., the first probe 11a, of which height adjustment value calculation is completed immediately before, i.e., the first bonding surface 5a.

When the height adjustment value for the second probe 11b is completed, the height adjustment unit 21 calculates the height adjustment value for the specific another probe, i.e., the third probe 11c corresponding to the third bonding surface 5c, which corresponds to another bonding surface located next closest to the second bonding surface 5b from the first bonding surface 5a. Here, the height adjustment value for the third probe 11c, which corresponds to the specific other probe, is determined by calculating the separation distance between the corresponding another specific bonding surface, i.e., the third bonding surface 5c, and the immediately previous bonding surface, i.e., the second bonding surface 5b corresponding to the immediately previous probe, i.e., the second probe 11b, for which the height adjustment value calculation was completed immediately before.

When the height adjustment value for the third probe 11c is completed, the height adjustment unit 21 calculates the height adjustment value for a specific another probe, i.e., the fourth probe 11d corresponding to the fourth bonding surface 5d, which corresponds to another bonding surface located farthest from the first bonding surface 5a. Here, the height adjustment value for the fourth probe 11d, which corresponds to the specific another probe, is determined by calculating the separation distance between the corresponding another specific bonding surface, i.e., the fourth bonding surface 5d, and the immediately previous bonding surface, i.e., the third bonding surface 5c corresponding to the immediately previous probe, i.e., the third probe 11c, for which the height adjustment value calculation is completed immediately before.

The height adjustment value calculation method for respective probes by the third height adjustment value calculation method described above corresponds to a method used for a case where focusing for the first probe 11a is performed first under the control of the control module 50 and then focusing for other probes is performed.

In some cases, the control module 50 may control focusing for the second probe 11b first and then focusing for other probes. In this case, the height adjustment unit 21 performs focusing for the second probe 11b according to the “A-scan-based focusing operation”, and when the height of the second probe 11b is adjusted, the height adjustment unit 21 calculates the height adjustment values for the first probe 11a, the third probe 11c, and the fourth probe 4d corresponding to other probes according to the “sequential adjustment-based focusing operation” and provides the height adjustment values to the control module 50. More specifically, the height adjustment unit 21 simultaneously calculates height adjustment values for the first probe 11a and the third probe 11c, which respectively correspond to the first bonding surface 5a and the third bonding surface 5c, which correspond to other bonding surfaces located close to the second bonding surface 5b, according to the “sequential adjustment-based focusing operation”, and then, calculates the height adjustment value for the fourth probe 11d corresponding to the fourth bonding surface 5d.

In this case, the height adjustment values for the first probe 11a and the third probe 11c are determined by calculating the separation distance between each of the first bonding surface 5a and the third bonding surface 5c, which correspond to the other specific bonding surfaces, which respectively corresponding thereto, and the second bonding surface 5b corresponding to the immediately previous bonding surface corresponding to the second probe 11b, which corresponds to the immediately previous probe for which the height adjustment value calculation is completed, and the height adjustment value for the fourth probe 11d is determined by calculating the separation distance between the fourth bonding surface 5d, which corresponds to the corresponding another specific bonding surface, and the third bonding surface 5c, which corresponds to the immediately previous bonding surface corresponding to the third probe 11c, which corresponds to the immediately previous probe for which the height adjustment value calculation is completed.

The separation distance between another specific bonding surface 5 corresponding to the specific another probe 11 and the immediately previous bonding surface 5 corresponding to the immediately previous probe 11 for which height adjustment value calculation is completed is determined by calculating the thickness of the layer 3 of the object to be inspected 1 located between another specific bonding surface 5 and the immediately previous bonding surface 5 using the ultrasonic reflection signal of the previous probe 11 for which height adjustment value calculation is completed.

For example, the separation distance between another specific bonding surface corresponding to the second probe 11b, which corresponds to a specific other probe, i.e., a second bonding surface 5b, and the first bonding surface 5a corresponding to the first probe 11a, which corresponds to the immediately previous probe for which the height adjustment value calculation is completed immediately before is determined by calculating the thickness of the second layer 3b, which corresponds to the layer of the object to be inspected 1 located between another specific bonding surface, i.e., the second bonding surface 5b, and the immediately previous bonding surface, i.e., the first bonding surface 5a using the ultrasonic reflection signal of the first probe 11a, which corresponds to the immediately previous probe for which the height adjustment value calculation is completed immediately before.

In addition, the separation distance between another specific bonding surface corresponding to the third probe 11c, which corresponds to a specific another probe, i.e., the third bonding surface 5b, and the second bonding surface 5b corresponding to the second probe 11b, which corresponds to the immediately previous probe for which the height adjustment value calculation is completed immediately before is determined by calculating the thickness of the second layer 3c, which corresponds to the layer of the object to be inspected 1 located between another specific bonding surface, i.e., the third bonding surface 5c, and the immediately previous bonding surface, i.e., the second bonding surface 5b using the ultrasonic reflection signal of the second probe 11b, which corresponds to the immediately previous probe for which the height adjustment value calculation is completed immediately before.

Meanwhile, the height adjustment unit 21 may calculate all height adjustment values for respective probes and provides them to the control module 50 at once, or transmit the height adjustment value for each probe to the control module 50 each time the height adjustment value for each probe is calculated.

However, as described above, since the separation distance between another specific bonding surface corresponding to another specific probe and the immediately previous bonding surface corresponding to the immediately previous probe for which the height adjustment value calculation is completed immediately before is determined by calculating the thickness of the layer of the object to be inspected located between another specific bonding surface and the immediately previous bonding surface using the ultrasonic reflection signal of the immediately previous probe for which the height adjustment value calculation is completed immediately before, the ultrasonic reflection signal of the of the immediately previous probe for which the height adjustment value calculation is completed immediately before should be used and analyzed. Therefore, it is preferable that the height adjustment unit 21 is allowed to transmit the height adjustment value for each probe to the control module 50 every time it is calculated, so that the height adjustment for the corresponding probe is completed, and the echo signal, i.e., the ultrasonic reflection signal, of the ultrasonic signal of the probe for which this height adjustment is completed may be used and analyzed to calculate the height adjustment value of the next probe.

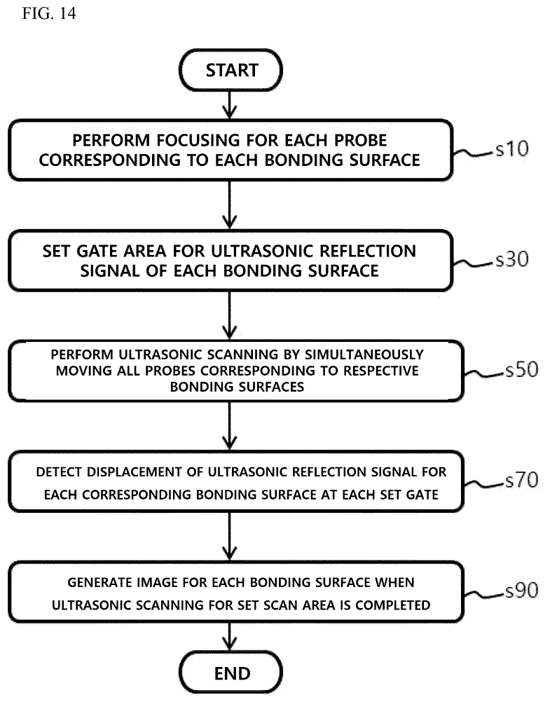

Hereinafter, a method of performing an ultrasonic inspection on each bonding surface 5 of the object to be inspected 1 using the ultrasonic inspection apparatus 100 will be schematically described with reference to FIG. 14 as follows.

First, a step of performing focusing for each probe corresponding to each bonding surface of the object to be inspected 1 is performed (s10). The method of performing focusing for each probe may be performed according to the various height adjustment value calculation methods described above and the control of the control module 50.

When the focusing performing step (s10) is completed, a step of setting a gate for the ultrasonic reflection signal of each bonding surface and setting a scan area of the object to be inspected 1 is performed (s30). Specifically, using scan information acquired through A-scan by the ultrasonic signal of each probe of which height adjustment is completed, a gate for the ultrasonic reflection signal of each probe is set, and the X-axis and Y-axis scan areas for the object to be inspected 1 are set. This is a step of preparing C-scanning mode by setting the same set frequency and probe having the highest amplitude for each bonding surface or inner surface reflection signal and setting the gate for the ultrasonic reflection signal of each probe.

When the step s30 is completed, a step of performing ultrasonic scanning by simultaneously moving all probes corresponding to respective bonding surfaces is performed (s50). This step s50 is a step in which C-scan is performed for the scan area set in the previous step s30, and is a step in which the mounting jig 13 is driven in the ±X and ±Y directions so that the plurality of probes are moved simultaneously and ultrasonic inspection is performed, thereby acquiring scan information for each of the plurality of probes.

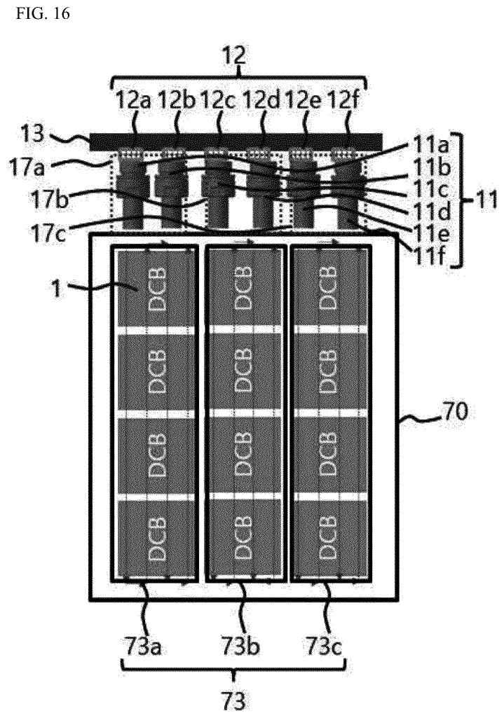

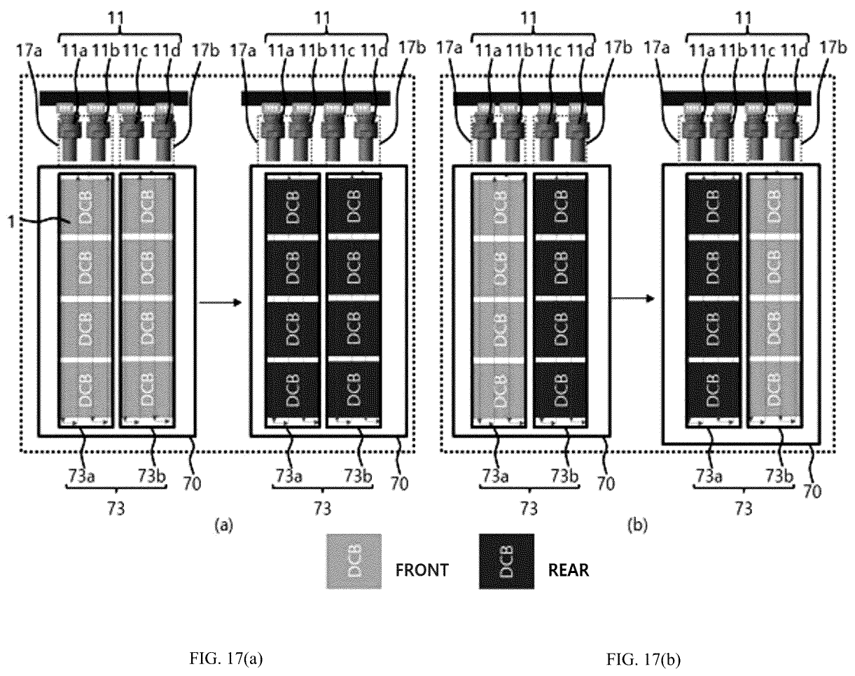

That is, an ultrasound inspection is performed on the entire region of the object to be inspected (or refers to the entire region of the objects to be inspected that are seated on a row in a seating region, see FIGS. 16 and 17 together), and scan information may be acquired by each probe. Each probe may have a different target scan region, and if overlapping regions are present, one of the overlapping regions may be ignored in a preset manner.

When the step s50 is completed, a step of detecting the displacement of the ultrasonic reflection signal for each corresponding bonding surface at each set gate is performed (s70). Specifically, the displacement of the ultrasonic reflection signal of each bonding surface is detected by processing the ultrasonic reflection signal of each probe at the gate.

When the step s70 is completed, an operation of generating and analyzing an image for each bonding surface is performed as the ultrasonic scanning for the set scan area is completed. In this step, the images for respective bonding surfaces may be synthesized into one scan image.

According to the ultrasonic inspection apparatus of the present invention described above, since the present invention has a configuration in which a plurality of probes each of which corresponds to each of a plurality of bonding surfaces of an object to be inspected to be subjected to an ultrasonic inspection are included, and ultrasonic inspection can be simultaneously performed on each of bonding surfaces after focusing of each probe on each of bonding surfaces to which each probe corresponds is performed of performing height adjustment for each probe, the advantage of improving the speed and precision of an ultrasonic inspection for an object to be inspected having a plurality of bonding surfaces occurs.

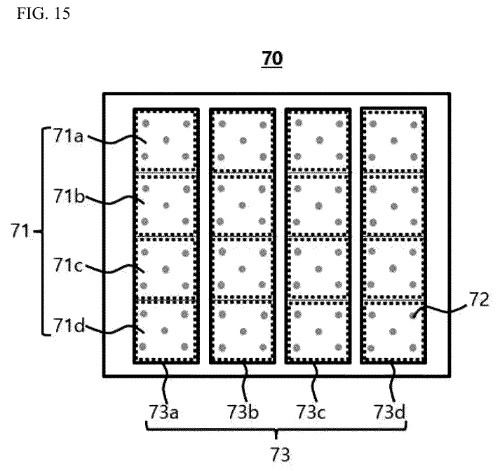

As shown in FIGS. 15 to 17, the ultrasonic inspection apparatus 100 according to the embodiment of the present invention is configured to include an inspection stage 70 that has a plurality of seating portions 71 on each of which an object to be inspected 1 is seated, an inspection module 10 that includes a plurality of probes 11 for performing ultrasonic scanning on a bonding surface 5 of an object to be inspected 1 seated on the inspection stage 70, a processing module 50 that transmits an ultrasonic generation signal so that each of the plurality of probes 11 may generate an ultrasonic signal, performs gate processing on an ultrasonic reflection signal detected by each of the plurality of probes 11 to output a displacement of the ultrasonic reflection signal for the bonding surface 5, and generates an image of the bonding surface based on the displacement of the ultrasonic reflection signal, and a control module 50 that controls the operation of the ultrasonic scanning of the inspection module 10 and controls signal processing of the processing module 30.

As shown in FIG. 15, the inspection stage 70 includes a plurality of seating regions 73 (73a, 73b, 73c, and 73d) that have a plurality of seating portions 71, on each of which seats the object to be inspected 1 is seated, and are separated from each other. At least two seating portions 71 (71a, 71b, 71c, and 71d) are formed in a row in each of the seating regions 73 (73a, 73b, 73c, and 73d).

FIG. 16 illustrates a configuration in which the seating region 73 is composed of a total of four seating regions, including a first seating region 73a, a second seating region 73b, a third seating region 73c, and a fourth seating region 73d that are sequentially spaced from each other, but the configuration is not limited thereto and may be composed of more or fewer seating regions.

In addition, FIG. 16 illustrates a configuration in which a plurality of seating portions 71 formed in each seating region 73 is composed of a total of four seating portions of a first seating portion 71a, a second seating portion 71b, a third seating portion 71c, and a fourth seating portion 71d that are arranged in a row, but the configuration is not limited thereto and may be composed of more or fewer seating portions.

It is preferable that an adsorption hole 72 for vacuum adsorption of the object to be inspected 1 to be seated thereon is formed on each of the seating portions 71 (71a, 71b, 71c, and 71d). In addition, it is preferable that an alignment position or alignment line be formed in each of the seating portions 71 (71a, 71b, 71c, and 71d) so that the object to be inspected 1 to be seated thereon may be seated on an aligned state.

In addition, it is preferable that the seating region may be configured to be varied so that each of the seating portions 71 (71a, 71b, 71c, and 71d) arranged and formed in each of the seating regions 73 (73a, 73b, 73c, and 73d) is made to correspond to objects to be inspected 1 of various sizes. That is, it is preferable that each seating region 73 (73a, 73b, 73c, and 73d) in which each of the plurality of seating portions 71 (71a, 71b, 71c, and 71d) are arranged and formed is configured so that the region can be varied in the width direction (direction in which respective seating region are separated from each other) and/or length direction (direction in which the plurality of seating portions are arranged in a row).

The plurality of objects to be inspected 1 seated on the inspection stage 70 are inspected by being subjected to ultrasonic scanning by the operation of the inspection module 10 including a plurality of probes 11. That is, the inspection module 10 includes the plurality of probes 11 that perform ultrasonic scanning on an ultrasonic inspection portion of the plurality of objects to be inspected seated on the inspection stage 70, specifically, a bonding surface.

As shown in FIG. 17, the plurality of probes 11 (11a, 11b, 11c, 11d, 11e, and 11f) are classified into a plurality of probe groups 17a, 17b, and 17c, and each of the probe groups 17a, 17b, and 17c is composed of at least one probe 11.

FIG. 17 illustrates that the plurality of probes 11 (11a, 11b, 11c, 11d, 11e, and 11f) are composed of three probe groups, including a first probe group 17a, a second probe group 17b, and a third probe group 17c, but is not limited thereto and may be composed of more or fewer probe groups.

In addition, FIG. 17 illustrates that the first probe group 17a is composed of the first probe 11a and the second probe 11b arranged adjacently, the second probe group 17b is composed of the third probe 11c and the fourth probe 11d arranged adjacently, and the third probe group 17c is composed of the fifth probe 11e and the sixth probe 11f arranged adjacently, but is not limited thereto, and each probe group may be composed of more or fewer probes 11. That is, the number of probes constituting each probe group may be variable, and the number of probes between the respective probe group may be configured to be the same or different.

The probe groups 17a, 17b, and 17c are correspondingly arranged one by one in the seating region 73 (73a, 73b, and 73c) under the control of the control module 50, and perform ultrasound scanning on a plurality of objects to be inspected 1 that are seated on the corresponding seating region 73 (73a, 73b, and 73c) under the control of the control module 50.

Referring to FIG. 17 to describe in more detail, the first probe group 17a is composed of a first probe 11a and a second probe 11b arranged adjacently under the control of the control module 50 and performs ultrasonic scanning on the plurality of objects to be inspected 1 that are arranged on the plurality of seating portions 71 arranged in a row in a first seating region 73a, the second probe group 17b is composed of a third probe 11c and a fourth probe 11d arranged adjacently under the control of the control module 50 and performs ultrasonic scanning on the plurality of objects to be inspected 1 that are arranged on the plurality of seating portions 71 arranged in a row in a second seating region 73b, and the third probe group 17c is composed of a fifth probe 11e and a sixth probe 11f arranged adjacently under the control of the control module 50 and performs ultrasonic scanning on the plurality of objects to be inspected 1 that are arranged on the plurality of seating portions 71 that are arranged in a row in a third seating region 73c.

As shown in FIG. 16, since the plurality of probe groups simultaneously perform ultrasonic scanning on the plurality of objects to be inspected 1 seated on the plurality of seating portions 71 formed in a row in each corresponding seating portion 73 along a movement path by x-y axis movement, the plurality of probe groups may have the advantage of being able to perform the ultrasound inspection on a large number of objects to be inspected by a single ultrasound scanning operation.

The plurality of probe groups may be configured to perform ultrasonic scanning while simultaneously moving along the movement path above the corresponding seating region 73 while being separated from each other, or may be configured to be mounted and connected to one mounting jig 13 so that the plurality of probe groups may perform ultrasonic scanning while simultaneously moving together.

However, in order to simplify a structure and control operation for the movement of the plurality of probe groups, it is more preferable to adopt a structure in which a plurality of probe groups move simultaneously while being mounted and connected to one mounting jig 13.

Therefore, as shown in FIG. 16, the plurality of probe groups according to the present invention are mounted on the mounting jig 13 constituting the inspection module 10, and perform ultrasonic scanning on the plurality of objects to be inspected 1 mounted on respective corresponding seating regions 73 while simultaneously moving under the control of the control module 50.

The number of probes 11 constituting the probe groups 17a, 17b, and 17c may be changed. That is, ultrasonic scanning may be performed by varying the number of probes 11 constituting the probe group 17a, 17b, and 17c corresponding to a specific seating region 73. To this end, it is preferable that the probes 11 constituting each probe group vary in position in a horizontal direction. For example, in FIG. 16, when it is intended to include the third probe 11c in the first probe group 17a while the third probe 11c is included in the second probe group 17b, the third probe 11c needs to move horizontally so that it is arranged above the first seating region 73a, and in this process, the second probe 11b may also need to move horizontally so that it is closer to the first probe 11a.

In this way, each probe 11 constituting each probe group is not directly fixedly connected to the mounting jig 13, but is mounted and connected to the mounting jig 13 through the adjustment connection part 12 that constitutes the inspection module 10 in a way of capable of being positionally moved in a horizontal direction. That is, each probe 11 constituting the probe group is mounted and connected to the mounting jig 13 through the adjustment connection part 12, and is connected so that its position in the horizontal direction may be adjusted by the adjustment connection part 12. The adjustment connection parts 12 may be configured in various structures as long as the corresponding probe 11 is mounted and connected to the mounting jig 13 and the corresponding probe 11 may be positionally moved in a horizontal direction.

FIG. 16 illustrates that the first probe 11a is mounted and connected to the mounting jig 13 through the first adjustment connection part 12a so that its position may be adjusted horizontally, the second probe 11b is mounted and connected to the mounting jig 13 through the second adjustment connection 12b so that its position may be adjusted horizontally, the third probe 11c is mounted and connected to the mounting jig 13 through the third adjustment connection 12c so that its position may be adjusted horizontally, the fourth probe 11d is mounted and connected to the mounting jig 13 through the fourth adjustment connection 12d so that its position may be adjusted horizontally, the fifth probe 11e is mounted and connected to the mounting jig 13 through the fifth adjustment connection 12e so its position may be adjusted horizontally, and the sixth probe 11f is mounted and connected to the mounting jig 13 through the sixth adjustment connection 12f so that so its position may be adjusted horizontally. As will be described below, each of the adjustment connection parts 12 allows the corresponding probe 11 to move in position even in a height direction.

In this way, since each of the probes 11 may be moved horizontally through the adjustment connection part 12 corresponding to the mounting jig 13, the number of probes 11 constituting each probe group corresponding to each seating region 73 may be changed variously as needed.

A processing module 30 is adopted and applied in order to enable ultrasonic scanning of the plurality of probes 11 constituting the inspection module 10 and to derive ultrasonic inspection results for the ultrasonic inspection portion of the object to be inspected 1, i.e., the bonding surface, according to the ultrasonic scanning.

As will be described below, the processing module 30 performs an operation of transmitting an ultrasonic generation signal so that each of the plurality of probes 11 may generate an ultrasonic signal, performing gate processing on the ultrasonic reflection signal detected by each of the plurality of probes 11 and outputting the displacement of an ultrasonic reflection signal for the bonding surface 5, and generating an image of the bonding surface based on the displacement of the ultrasonic reflection signal.

In addition, as will be described below, the ultrasonic scanning operation of the inspection module 10 and the signal processing of the processing module 30 are performed under the control of the control module 50, and the object to be inspected 1 may have a plurality of bonding surfaces 5. Therefore, the control module 50 controls the inspection module 10 and the processing module 30 so that ultrasonic scanning may be performed on the plurality of bonding surfaces 5 and ultrasonic inspection results may be generated.

For example, the control module 50 may allow each probe group corresponding to each seating region 73 to be composed of a plurality of probes 11 through horizontal position movement of the corresponding probe 11, and perform control so that ultrasonic scanning is performed on all of the plurality of bonding surfaces 5 of the object to be inspected 1 seated on each seating region 73 at once, and in some case, or perform control so that ultrasonic scanning is performed twice through an inversion operation of the object to be inspected 1 illustrated in FIG. 17.

The latter case corresponds to a method of performing ultrasonic scanning by separately dividing the bonding surface 5 near the upper surface of the object to be inspected 1 and the bonding surface 5 near the lower surface thereof. To this end, it is preferable that the ultrasonic inspection apparatus 100 according to the present invention further includes an inversion module (not shown) capable of inversing a plurality of objects to be inspected 1 that are seated on each of the seating regions 73.

(a) of FIG. 17 illustrates that, in a state where the object to be inspected 1 is seated on the first seating region 73a and the second seating region 73b so that the upper surface thereof is visible, ultrasonic scanning is performed on the bonding surface 5 close to the upper surface through the first probe group 17a and the second probe group 17b that respectively correspond thereto, and then, in a state where the object to be inspected 1 is seated on the first seating region 73a and the second seating region 73b through the inversion module so that the lower surface thereof is visible, ultrasonic scanning is performed on the bonding surface 5 close to the lower surface through the first probe group 17a and the second probe group 17b that respectively correspond thereto.

In addition, (b) of FIG. 17 illustrates that, in a state where the upper surface of the object to be inspected 1 is seated on the first seating region 73a so that the upper surface thereof is visible and the object to be inspected 1 is seated on the second seating region 73b so that the lower surface thereof is visible, ultrasonic scanning is performed on the bonding surfaces 5 close to the upper surface and the lower surface through the first probe group 17a and the second probe group 17b that respectively correspond thereto, and then, in a state where, through the inversion module, the upper surface of the object to be inspected 1 is seated on the first seating region 73a so that the upper surface thereof is visible and the lower surface of the object to be inspected 1 is seated on the second seating region 73b so that the lower surface thereof is visible, ultrasonic scanning is performed on the bonding surfaces 5 close to the lower surface and the upper surface through the first probe group 17a and the second probe group 17b that respectively correspond thereto.

However, the ultrasonic scanning operation through such an inversion module may cause various problems such as structural complexity, complexity of control operation, and increase in ultrasonic inspection time due to the adoption of the inversion module.

To this end, the present invention adopts and applies a method of performing ultrasonic scanning on an object to be inspected 1 having a plurality of bonding surfaces 5 at once through a probe group composed of a plurality of probes 11. That is, in the present invention, when the object to be inspected 1 seated on a plurality of seating portions 71 of a specific seating region 73 has a plurality of bonding surfaces, a corresponding probe group is configured with the same number of probes 11 as the plurality of bonding surfaces, and a method that allows for simultaneous ultrasonic inspection of all bonding surfaces through a rapid focusing process is adopted and applied.

Specifically, the plurality of probes 11 constituting the probe group according to the present invention respectively perform ultrasonic scanning corresponding to the plurality of bonding surfaces 5 of the object to be inspected 1 formed with a plurality of layers 3 as shown in FIG. 10, and the ultrasonic inspection apparatus 100 according to the present invention is configured to further include a height adjustment unit 21 that calculates a height adjustment value for each probe 11 and provides the height adjustment value to the control module 50 so that focusing may be performed on each corresponding bonding surface 5 of each probe 11 constituting the probe group.

A focusing performance process by the height adjustment unit 21 and the control module 50 described below is individually performed for each probe 11 constituting each probe group corresponding to each seating region 73. That is, the focusing performance process is individually performed for each probe group composed of the number of probes corresponding to the number of bonding surfaces of the object to be inspected 1. Therefore, the description related to focusing is a description of the probe 11 constituting a specific probe group, but focusing for other probe groups is also applied equally. In addition, hereinafter, the focusing process for the probe is described, and at the same time, the configuration and operation of the inspection module 10, the processing module 30, and the control module 50 constituting the present invention are also described.

The inspection module 10 includes a plurality of probes 11, and these plurality of probes 11 may be classified into a plurality of probe groups, and each of the plurality of probes 11 constituting each probe group perform ultrasonic scanning corresponding to each of a plurality of bonding surfaces 5 of the object to be inspected 1 formed of a plurality of layers 3.

That is, as shown in FIG. 17, the inspection module 10 according to the present invention includes a first probe to k-th probe 11, and these probes may be classified into a plurality of probe groups each of which is composed of at least one probe, and each of the plurality of probes constituting each probe group perform ultrasonic scanning corresponding to each of a first to n-th bonding surfaces 5 of the object to be inspected 1 in sequence.

In order to perform an ultrasonic inspection on an object to be inspected 1 corresponding to the direct copper bonding (DCB) substrate as shown in (a) of FIG. 10, a specific probe group, for example, a first probe group 17a, may include a first probe 11a that performs ultrasonic scanning corresponding to the first bonding surface 5a and a second probe 11b that performs ultrasonic scanning corresponding to the second bonding surface 5b, as shown in FIG. 11. That is, in this case, the first probe group 17a may be composed of two probes 11a and 11b and perform ultrasonic scanning on the bonding surfaces 5a and 5b of the object to be inspected 1 that are seated on the seating portions 71 that are arranged and formed in a row in the corresponding first seating region 73a.

In order to perform an ultrasonic inspection on the object to be inspected 1 corresponding to the active metal brazing (AMB) substrate shown in (b) of FIG. 10, a specific probe group, for example, the first probe group 17a may include a first probe 11a that performs ultrasonic scanning corresponding to the first bonding surface 5a, a second probe 11b that performs ultrasonic scanning corresponding to the second bonding surface 5b, a third probe 11c that performs ultrasonic scanning corresponding to the third bonding surface 5c, and a fourth probe 11d that performs ultrasonic scanning corresponding to the fourth bonding surface 5d, as shown in FIG. 12. That is, in this case, the first probe group 17a is composed of four probes 11a to 11d and may perform ultrasonic scanning on the bonding surfaces 5a to 5d of the object to be inspected 1 to be seated on the seating portions 71 arranged and formed in a row in the corresponding first seating region 73a.

Meanwhile, the ultrasonic inspection apparatus according to one embodiment of the present invention is preferably configured so that the mounting jig 13, the adjustment connection part 12, the moving assembly 15, the injection control unit 38, the control module 50, the height adjustment part 21, etc. described above are able to adjust or control the respective probes 11 constituting the probe group, and to adjust or control the probes 11 in a probe group unit. This may also be applied similarly when performing the first to third height adjustment value calculation methods, as shown in FIGS. 11 and 12. Descriptions of matters that overlap with the above-described contents will be omitted.

According to the ultrasonic inspection apparatus of the present invention described above, since the present invention has a configuration in which the inspection stage is configured so that the seating regions, in each of which at least two or more seating portions are arranged in a row, are arranged to be separated from each other, has a configuration in which the plurality of probes are classified into a plurality of probe groups, each of which is composed of at least one probe, and has a configuration in which each of the probe group is arranged correspondingly on the seating regions one by one, so that ultrasonic scanning can be performed on a plurality of objects to be inspected seated on the corresponding seating region, the advantage of significantly saving the time, effort and cost for ultrasound inspection by allowing ultrasonic inspection to be simultaneously performed on a plurality of objects to be inspected seated on the inspection stage and improving the ultrasonic inspection efficiency through such savings.

In addition, according to the present invention, since a configuration in which each of a plurality of probes constituting a probe group performs ultrasound scanning corresponding to each of a plurality of bonding surfaces of an object to be inspected formed of a plurality of layers, and height adjustment is performed for each probe constituting the probe group so that focusing of each probe is performed for each corresponding bonding surface to which each probe corresponds, and then ultrasonic inspection is simultaneously performed on the bonding surfaces are adopted, an effect of improving the speed and precision of ultrasonic inspection of the object to be inspected having a plurality of bonding surfaces occurs.

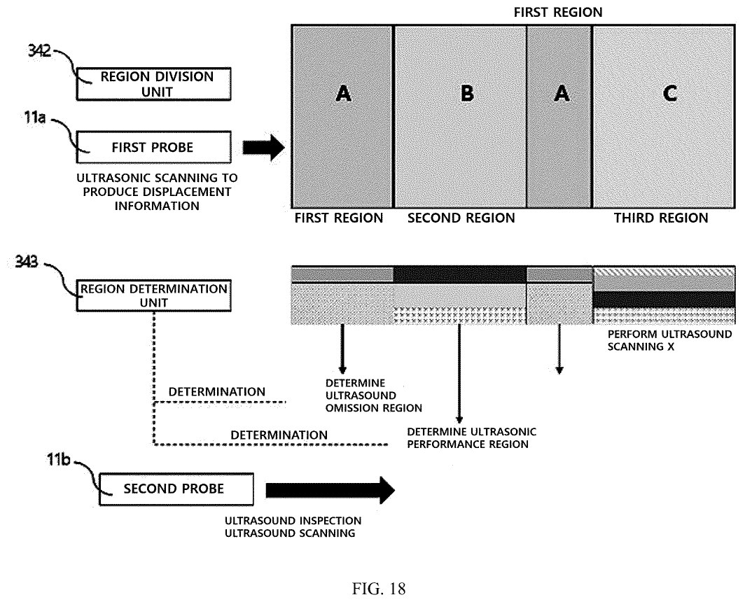

FIG. 18 is a schematic diagram for describing a process using a region division unit and a region determination unit of an ultrasonic inspection apparatus according to an embodiment of the present invention. Referring to FIG. 18, an ultrasonic inspection apparatus according to an embodiment of the present invention includes a region division unit 342 and a region determination unit 343.

In order to distinguish a plane of an object to be inspected, the probes may be divided into a first probe 11a and a second probe 11b and used. As described above, the probes may be divided into the first probe 11a for calculating displacement information and the second probe 11b for ultrasonic inspection of the inspection surface, and the region may be divided first by an operation of the first probe 11a based on the plane of the object to be inspected.

The first probe 11a uses displacement information calculated using the detected ultrasonic reflection signal. The displacement information is transmitted to the height adjustment unit 21, and is computed and processed in a preset manner in the height adjustment unit 21, so that the thickness of the layer of the object to be inspected may be calculated.

This thickness information of the object to be inspected is transmitted to the region division unit 342, and the region division unit 342 is configured to model layer shape information of the object to be inspected. The region division unit 342 divides the entire plane region of the object to be inspected into a first to m-th regions by determining regions having the same layer shape information. In FIG. 18, although the plane of the object to be inspected is illustrated, and although it is divided into four regions, it may be confirmed that the first region overlaps if the layer shape information is compared and determined between the regions. That is, the region division unit 342 may compute the layer shape information by calculating the thickness of the layer of the object to be inspected through the height adjustment unit 21 based on the displacement information calculated using the ultrasonic reflection signal detected by the first probe 11a, and divide the region of the object to be inspected into the first to m-th regions by producing regions having the same layer shape information for the plane of the object to be inspected.

The region determination unit 343 determines whether to perform an ultrasonic inspection by the second probe for the first to third regions divided by the region division unit 342. The region determination unit 343 divides the regions into an ‘ultrasonic performance region’ where an ultrasonic inspection is performed, and an ‘ultrasonic omission region’ where an ultrasonic inspection is omitted thereafter. The region determination unit 343 may set the ultrasonic omission region, so that the ultrasonic scanning operation of the second probe 11b may be omitted, and accordingly, a more rapid inspection may be performed. That is, the region determination unit 343 may set the ultrasonic performance region and the ultrasonic omission region by determining in a preset manner whether to perform an ultrasonic inspection by the second probe 11b for the first to m-th regions divided by the region division unit 342.

As an example, when the inspection information is transmitted to the region determination unit 343 and the first region is set as an ultrasonic omission region after the ultrasonic inspection of the second probe 11b for the first region is performed, the ultrasound inspection for the first region may be omitted after the setting of the first region. It is preferable that the region set as the ultrasonic omission region be set as a region determined to have a relatively low probability of defects according to preset conditions, and the conditions for setting the region as the ultrasonic omission region may be set through a pre-learned machine learning model (not shown). In a situation where a rapid inspection is required, the omission of ultrasonic inspection using this region determination unit 343 may be very effective.

That is, a k-th region (wherein, k is a natural number of m or less) divided by the region division unit 342 may be a continuous region based on the plane. In addition, when the k-th region is set as an ultrasonic omission region, the region determination unit 343 may omit the ultrasonic inspection by the second probe 11b for a region having the same layer arrangement as the k-th region, among the first to m-th regions.

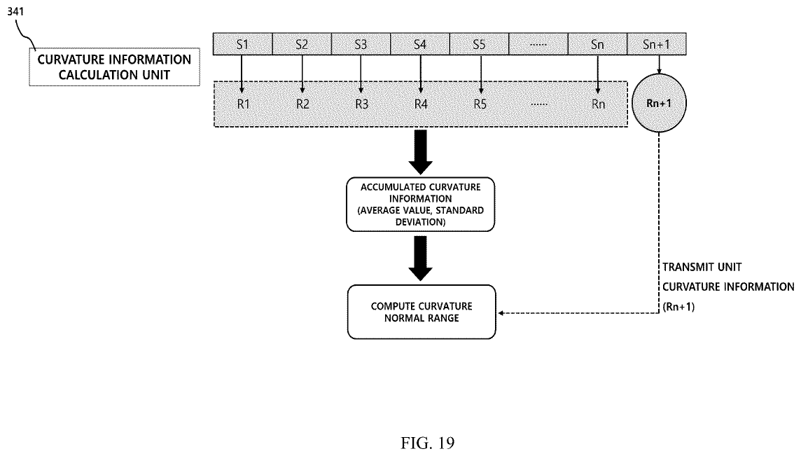

FIG. 19 is a schematic diagram for describing a process using a curvature information calculation unit of an ultrasonic inspection apparatus according to an embodiment of the present invention. Referring to FIG. 19, the present invention includes a curvature information calculation unit 341 that calculates curvature information of a corresponding section using displacement information acquired through the first probe 11a. The process of acquiring displacement information through the first probe 11a has been described above, and thus description thereof will be omitted.

The curvature information calculation unit 341 calculates unit curvature information for each preset unit section of an inspection surface, and an area or length of a unit section may vary depending on the designer's selection. FIG. 19 illustrates a state in which it is divided into a first section S1 to an N-th section Sn, and a configuration in which calculate each piece of unit curvature information R1 to Rn for each of these sections is calculated is adopted. This method is very useful for a relatively curved or flexed object to be inspected rather than a flat object to be inspected.

The curvature information calculation unit 341 determines that a section in which the unit curvature information changes rapidly is an inspection error or defect section, and the section is set to be subjected to the inspection again using the first probe 11a. The unit curvature information is set to be determined by being compared with accumulated curvature information. The accumulated curvature information includes an average value and standard deviation of the unit curvature information, and a curvature tolerance range may be set based on the average value and standard deviation.

That is, accumulated curvature information for the first to n-th sections is compared with unit curvature information of an (n+1)-th section, and if the unit curvature information of the (n+1)-th section exceeds a preset range (curvature tolerance range) compared to the accumulated curvature information, the (n+1)-th section may be determined as an ‘abnormal section.’

By applying the standard deviation as a parameter in addition to the average value of the unit curvature information, the curvature tolerance range is not a fixed range, but can continuously change during the ultrasonic inspection process, and thus a more accurate and flexible range may be computed.

Here, the curvature information calculation unit 341 may be controlled to compute the unit curvature information for the (n+1) section again in such a way that, firstly, if the (n+1) section is determined to be an abnormal section, secondly, the first probe 11a is caused to be returned to a starting point of the (n+1) section through the mounting jig 13. According to this series of processes, before the ultrasonic inspection by the second probe 11b is performed, an abnormal section can be determined in advance and thus, a more accurate ultrasonic inspection can be performed.

The effects of the ultrasonic inspection apparatus of the present invention, which has the problems to be solved and the means to solve the problems described above, are as follows.

First, since the present invention has a configuration in which the first probe which performs ultrasonic scanning for calculating displacement information on the inspection surface of the sample and the second probe which performs ultrasonic scanning for the ultrasonic inspection on the inspection surface of the sample are included and ultrasonic scanning is performed while the height of the second probe is varied based on displacement information calculated using the ultrasonic reflection signal detected by the first probe, an advantage of being able to perform rapid and highly precise ultrasonic inspection even on a sample with a non-flat or non-horizontal inspection surface, such as a curved sample occurs.

Second, since the present invention is configured to be able to set the scanning pattern corresponding to the separation information between the scanning points for each scan line of the first probe and second probe to be identical or different, an effect of allowing a rapid ultrasonic inspection to be performed with guaranteed precision using an optimal scanning pattern for a sample having a non-uniform degree of curvature occurs.

Third, since the present invention has a configuration in which a plurality of probes each of which corresponds to each of a plurality of bonding surfaces of an object to be inspected to be subjected to an ultrasonic inspection are included, and ultrasonic inspection can be simultaneously performed on each of bonding surfaces after focusing of each probe on each of bonding surfaces to which each probe corresponds is performed of performing height adjustment for each probe, the advantage of improving the speed and precision of an ultrasonic inspection for an object to be inspected having a plurality of bonding surfaces occurs.

Fourthly, since the present invention has a configuration in which the inspection stage is configured so that the seating regions, in each of which at least two or more seating portions are arranged in a row, are arranged to be separated from each other, has a configuration in which the plurality of probes are classified into a plurality of probe groups, each of which is composed of at least one probe, and has a configuration in which each of the probe group is arranged correspondingly on the seating regions one by one, so that ultrasonic scanning can be performed on a plurality of objects to be inspected seated on the corresponding seating region, the advantage of significantly saving the time, effort and cost for ultrasound inspection by allowing ultrasonic inspection to be simultaneously performed on a plurality of objects to be inspected seated on the inspection stage and improving the ultrasonic inspection efficiency through such savings. In addition, according to the present invention, since a configuration in which each of a plurality of probes constituting a probe group performs ultrasound scanning corresponding to each of a plurality of bonding surfaces of an object to be inspected formed of a plurality of layers, and height adjustment is performed for each probe constituting the probe group so that focusing of each probe is performed for each corresponding bonding surface to which each probe corresponds, and then ultrasonic inspection is simultaneously performed on the bonding surfaces are adopted, an effect of improving the speed and precision of ultrasonic inspection of the object to be inspected having a plurality of bonding surfaces occurs.

Although embodiments according to the present invention have been described above, these are merely exemplary, and those of ordinary skill in the art will understand that various modifications and equivalent scope of embodiments are possible therefrom. Therefore, the true technical protection scope of the present invention should be determined by the following patent claims.

### LIST OF REFERENCE NUMERALS

1: sample
3: inspection surface
10: inspection module
11: probe
11a: first probe
11b: second probe
11c: third probe
11d: fourth probe
11e: fifth probe
11f: sixth probe
12: adjustment connection part
12a: first adjustment connection part
12b: second adjustment connection part
12c: third adjustment connection part
12d: fourth adjustment connection part
12e: fifth adjustment connection part
12f: sixth adjustment connection part
13: mounting jig
15: moving assembly
17a: first probe group
17b: second probe group
17c: third probe group
20: displacement information generation unit
21: height adjustment unit
25: scanning pattern setting unit
30: processing module
31: oscillator
32: timing unit
33: signal input unit
35: signal processing unit
36: image generation unit
37: display unit
38: scanning control unit
50: control module
70: inspection stage
71: seating portion
71a: first seating unit
71b: second seating unit
71c: third seating unit
71d: fourth seating unit
72: adsorption hole
73: seating region
73a: first seating region
73b: second seating region
73c: third seating region
73d: fourth seating region
100: ultrasonic inspection apparatus
341: curvature information calculation unit
342: region division unit
343: region determination unit

What is claimed is:

1. An ultrasonic inspection apparatus comprising:
an inspection module that includes a plurality of probes performing ultrasonic scanning on an object to be inspected;
a processing module that transmits an ultrasonic generation signal so that the plurality of probes generate an ultrasonic signal, and generates an image of an inspection surface of the object to be inspected based on an ultrasonic reflection signal detected by the probes; and
a control module that controls an ultrasonic scanning operation of the inspection module and controls signal processing of the processing module, wherein
the control module controls a focusing position of the probes by adjusting a distance between each of the plurality of probes and the object to be inspected.

2. The ultrasonic inspection apparatus of claim 1, wherein
the plurality of probes are divided into a first probe that performs ultrasonic scanning for calculating displacement information on the inspection surface of the object to be inspected and a second probe that performs ultrasonic scanning for an ultrasonic inspection of the inspection surface, and the processing module
performs gate processing on the ultrasonic reflection signal detected by the second probe to output a displacement of the ultrasonic reflection signal for the inspection surface and generate an image of the inspection surface based on the displacement,
includes a displacement information calculation unit that calculates displacement information corresponding to a displacement value in a height direction for a reference position of the inspection surface using the ultrasonic reflection signal detected by the first probe, and
performs control so that ultrasonic scanning is performed while a height of the second probe is varied based on the displacement information calculated by the displacement information calculation unit.

3. The ultrasonic inspection apparatus of claim 2, wherein
the first and second probes are respectively connected to mounting jigs, and are connected to the mounting jigs in a first direction arrangement form in which the first and second probes are arranged in a row along a preset scan line or in a second direction arrangement form in which the first and second probes are arranged one by one along arrangement directions of at least two or more scan lines.

4. The ultrasonic inspection apparatus of claim 3, wherein
when the first and second probes are arranged in the first direction arrangement form, the processing module performs control so that ultrasound scanning for a (k+1)-th scan line is performed while the height of the second probe is varied based on displacement information calculated using the ultrasonic reflection signal detected by the first probe for a k-th scan line.

5. The ultrasonic inspection apparatus of claim 4, wherein
the processing module performs control so that the first probe performs ultrasonic scanning for calculating displacement information for the (k+1)-th scan line when ultrasonic scanning is performed for the (k+1)-th scan line while the height of the second probe is varied, and
the displacement information calculation unit calculates the displacement information for the (k+1)-th scan line using the ultrasonic reflection signal detected for the (k+1)-th scan line.

6. The ultrasonic inspection apparatus of claim 3, wherein
when the first and second probes are arranged in the second direction arrangement form, the processing module performs control so that ultrasound scanning for a k-th scan line is performed while the height of the second probe is varied based on displacement information calculated using the ultrasonic reflection signal detected by the first probe for the k-th scan line.

7. The ultrasonic inspection apparatus of claim 3, wherein
the mounting jigs are configured to move in the first direction or the second direction,
the processing module includes a curvature information calculation unit that calculates curvature information based on the displacement information acquired through the first probe when the mounting jigs move, and
the curvature information calculation unit calculates unit curvature information for each preset unit section of the inspection surface, compares accumulated curvature information for a first to n-th sections with the unit curvature information of an (n+1)-th section, and determines the (n+1)-th section an abnormal section when the unit curvature information of the (n+1)-th section exceeds a preset range compared to the accumulated curvature information.

8. The ultrasonic inspection apparatus of claim 7, wherein
the curvature information calculation unit is controlled to compute the unit curvature information for the (n+1) section again in such a way that, firstly, if the (n+1)-th section is determined to be an abnormal section, secondly, the first probe is caused to be returned to a starting point of the (n+1)-th section through the mounting jig.

9. The ultrasonic inspection apparatus of claim 7, wherein
the curvature information calculation unit calculates the accumulated curvature information using an average value of the unit curvature information of each of the first to nth sections, and
the preset range is a range that varies as ultrasound scanning is performed of being calculated based on a standard deviation of the unit curvature information of each of the first to nth sections.

10. The ultrasonic inspection apparatus of claim 3, wherein
the processing module further includes a scanning pattern setting unit that manages a scanning pattern corresponding to separation information between scanning points for each of scan lines of the first and second probes, and
the scanning pattern setting unit arranges the scanning points of each scan line at equal intervals or at different intervals.

11. The ultrasonic inspection apparatus of claim 10, wherein
when the first and second probes are in the first direction arrangement form, scanning points of each of a k-th scan line and a (k+1)-th scan line are separated from each other by equal intervals, and the k-th scan line and the (k+1)-th scan line are formed with the same scanning pattern.

12. The ultrasonic inspection apparatus of claim 10, wherein
when the first and second probes are in the second direction arrangement form, scanning points of each of a k-th scan line and a (k+1)-th scan line may be separated from each other by equal intervals or by different intervals, and the k-th scan line and the (k+1)-th scan line may be formed the same scanning pattern.

13. The ultrasonic inspection apparatus of claim 1, wherein
the processing module further includes a height adjustment unit that calculates a height adjustment value for each probe and provides the height adjustment value to the control module so that focusing may be performed for each bonding surface corresponding to each probe, and
the height adjustment unit uses height corresponding information of each probe at which a displacement of the ultrasonic reflection signal for each bonding surface corresponding to each probe is maximized as the height adjustment value.

14. The ultrasonic inspection apparatus of claim 13, wherein
the height adjustment unit calculates a thickness of each layer of the object to be inspected through a time difference of the ultrasonic reflection signal for each bonding surface, calculates the separation distance between the specific bonding surface and each of other bonding surfaces, and then provides each calculated separation distance as a height adjustment value for each of other probes to the control module.

15. The ultrasonic inspection apparatus of claim 13, wherein
the height adjustment unit sequentially calculates the height adjustment value for each of other probes corresponding to each of other bonding surfaces from another bonding surface located close to the specific bonding surface to another bonding surface located far from the specific bonding surface in order and provides the height adjustment values to the control module, and
the height adjustment value for a specific another probe is determined by calculating a separation distance between a corresponding another specific bonding surface and an immediately previous bonding surface corresponding to an immediately previous probe for which the height adjustment value calculation is completed immediately before.

16. The ultrasonic inspection apparatus of claim 15, wherein
the separation distance is determined by calculating a thickness of a layer of an object to be inspected located between the another specific bonding surface and the immediately previous bonding surface through an ultrasonic reflection signal of the immediately previous probe for which the calculation of the height adjustment value is completed.

17. The ultrasonic inspection apparatus of claim 14, wherein
the plurality of probes are divided into a first probe that performs ultrasonic scanning for calculating displacement information on the inspection surface of the object to be inspected and a second probe that performs ultrasonic scanning for ultrasonic inspection of the inspection surface, and
the processing module further includes an region division unit that computes layer shape information by calculating the thickness of the layer of the object to be inspected through the height adjustment unit based on the displacement information calculated using the ultrasonic reflection signal detected by the first probe, and divides a region of the object to be inspected into a first to m-th regions by calculating regions having the same layer shape information for a plane of the object to be inspected.

18. The ultrasonic inspection apparatus of claim 17, wherein
the processing module further includes a region determination unit that sets an ultrasonic performance region and an ultrasonic omission region by determining in a preset manner whether to perform an ultrasonic inspection by the second probe for the first to m-th regions divided by the region division unit.

19. The ultrasonic inspection apparatus of claim 18, wherein
the k-th region divided by the region division unit (wherein, k is a natural number less than or equal to m) is a continuous region based on a plane, and
the region determination unit determines that the ultrasonic inspection by the second probe is omitted for a region having the same layer arrangement pattern among the first to m-th regions when the k-th region is set as an ultrasonic omission region.

20. The ultrasonic inspection apparatus of claim 1, further comprising
an inspection stage having a plurality of seating portions, each of which seats the object to be inspected, wherein
the inspection stage further includes a plurality of seating regions separated from each other, and at least two seating portions are formed in a row in each of the seating regions,
the plurality of probes are classified into at least two probe groups, and each of the probe groups may be composed of at least one probe, and
each of the probe groups is connected to the mounting jig so as to be correspondingly arranged in each of the seating regions, performs ultrasonic scanning on a plurality of objects to be inspected seated on the corresponding seating region, and individual probes constituting the probe group are connected to the mounting jigs through adjustment connection parts, so that positions of the probes in the horizontal direction are adjusted.
